(19) United States
(12) Patent Application Publication
(10) Pub. No.: US 2026/0312348 A1
(43) Pub. Date: Oct. 8, 2026

(54) ELECTRICAL CONNECTION UNIT

(71) Applicant: Yazaki Corporation, Tokyo (JP)

(72) Inventors: Kazuki KOBAYASHI, Kakegawa-shi (JP); Hiroka Nahara, Kakegawa-shi (JP)

(73) Assignee: Yazaki Corporation, Tokyo (JP)

(21) Appl. No.: 19/553,706

(22) Filed: Mar. 2, 2026

(30) Foreign Application Priority Data
Apr. 7, 2025 (JP) 2025-062957

(51) Int. Cl. H01R 25/16; H01R 13/621; H01R 13/66

(52) U.S. Cl. CPC H01R 25/162; H01R 13/6215; H01R 13/66

(57) ABSTRACT

The electrical connection unit includes a first electronic component, a first connection component, a first routing member, and a second routing member. The first electronic component includes a component body, a first terminal, and a second terminal. The first connection component is connected to the first terminal. The first routing member includes a first plate portion. The first plate portion is disposed on a first side with respect to the first electronic component, and overlaps at least one of the first electronic component or the first connection component when viewed from the third direction. The second routing member includes a second plate portion. The second plate portion is disposed on a second side opposite to the first side with respect to the first electronic component, and overlaps at least one of the first electronic component or the first connection component when viewed from the third direction.

### BACKGROUND OF THE INVENTION

### Field of the Invention

An embodiment of the present invention relates to an electrical connection unit. Priority is claimed on Japanese Patent Application No. 2025-062957 filed in Japan on April 7, 2025, the content of which is incorporated herein by reference.

### Description of Related Art

An electrical connection unit including electronic components and a routing member electrically connected to the electronic components is known.

### Prior Art Document

### Patent Document

Patent Document 1: Japanese Unexamined Patent Application, First Publication No. 2024-037492

### SUMMARY OF THE INVENTION

### Problems to be Solved by the Invention

An electrical connection unit is expected to be downsized.

An embodiment provides an electrical connection unit that can be downsized.

### Means for Solving the Problem

An electrical connection unit of an embodiment includes a first electronic component, a first connection component, a first routing member, and a second routing member. The first electronic component includes a component body, a first terminal, and a second terminal. The first connection component is connected to the first terminal of the first electronic component. The first routing member, when a direction in which the first terminal and the second terminal are adjacent to each other is defined as a first direction, a direction intersecting the first direction and in which the component body and the first connection component are adjacent to each other is defined as a second direction, and a direction intersecting the first direction and the second direction is defined as a third direction, includes a first plate portion along the first direction and the second direction. The first plate portion is disposed on a first side in the third direction with respect to the first electronic component, and overlaps at least one of the first electronic component or the first connection component when viewed from the third direction. The second routing member includes a second plate portion along the first direction and the second direction. The second plate portion is disposed on a second side opposite to the first side in the third direction with respect to the first electronic component, and overlaps at least one of the first electronic component or the first connection component when viewed from the third direction. Between the plate thickness of the second plate portion and the plate thickness of the first plate portion, the smaller plate thickness is equal to or larger than half of the larger plate thickness.

An electrical connection unit of an embodiment includes a first electronic component, a second electronic component, a first routing member, and a second routing member. The first electronic component includes a first terminal and a second terminal adjacent to each other in a first direction. The second electronic component is adjacent to the first electronic component in a second direction intersecting the first direction. The first routing member includes a first plate portion along the first direction and the second direction. The first plate portion is, when a direction intersecting the first direction and the second direction is defined as a third direction, disposed on a first side in the third direction with respect to the first electronic component and the second electronic component, and overlaps the first electronic component when viewed from the third direction. The second routing member includes a second plate portion along the first direction and the second direction. The second plate portion is disposed on a second side opposite to the first side in the third direction with respect to the first electronic component and the second electronic component, and overlaps the first electronic component and the second electronic component when viewed from the third direction. Between the plate thickness of the second plate portion and the plate thickness of the first plate portion, the smaller plate thickness is equal to or larger than half of the larger plate thickness.

### Advantageous Effects of the Invention

According to an embodiment, the electrical connection unit can be downsized.

### BRIEF DESCRIPTION OF THE DRAWINGS

FIG. 1 is a partially exploded perspective view of an electrical connection unit of an embodiment.

FIG. 2 is a perspective view showing a first-type electronic component of the embodiment.

FIG. 3 is a further partially exploded perspective view of the structure illustrated in FIG. 2.

FIG. 4 is a perspective view showing a second-type electronic component of the embodiment.

FIG. 5 is a perspective view illustrating an aspect of the electrical connection unit of the embodiment.

FIG. 6 is a cross-sectional view taken along line F6-F6 of the structure illustrated in FIG. 5.

FIG. 7 is a plan view illustrating a first structure of the embodiment.

FIG. 8 is a cross-sectional view taken along line F8-F8 of the structure illustrated in FIG. 5.

FIG. 9 is a plan view illustrating a second structure of the embodiment.

FIG. 10 is a perspective view showing a structure related to one electronic component of the embodiment.

FIG. 11 is a front view showing a structure related to one electronic component of the embodiment.

FIG. 12 is a cross-sectional view showing first to third base members of the embodiment.

FIG. 13 is a perspective view showing the first base member of the embodiment.

FIG. 14 is a perspective view showing the second base member of the embodiment.

FIG. 15 is a perspective view showing the third base member of the embodiment.

FIG. 16 is another perspective view showing the third base member of the embodiment.

FIG. 17 is a perspective view showing connection components of a first modification of the embodiment.

FIG. 18 is a cross-sectional view illustrating an electrical connection unit of the first modification of the embodiment.

FIG. 19 is a perspective view showing connection components of a second modification of the embodiment.

FIG. 20 is a cross-sectional view illustrating an electrical connection unit of the second modification of the embodiment.

FIG. 21 is a perspective view showing connection components of a third modification of the embodiment.

FIG. 22 is a cross-sectional view illustrating an electrical connection unit of the third modification of the embodiment.

### DETAILED DESCRIPTION OF THE INVENTION

Hereinafter, an embodiment will be described with reference to the drawings. In the following description, constitutions having the same or similar functions are denoted by the same reference numbers. Then, redundant descriptions of these constitutions may be omitted. Note that the constitution described below does not limit the scope of the embodiment.

In the present disclosure, terms are defined as described below. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “facing”, “overlapping”, or “adjacent” means that virtual projection images of two target objects overlap each other when viewed from a specific direction. For example, the term “facing” or “overlapping” is not limited to a case where two target objects directly face each other, and may include a case where two target objects face each other in a state in which another member or a gap exists between the two target objects. In addition, the term “facing” or “overlapping” is not limited to a case of completely overlapping when viewed from the specific direction, and may include a case of at least partially overlapping. “Adjacent” is not limited to a case where the same kind or corresponding two target objects are directly adjacent to each other, and may include a case where two target objects are arranged in a state where another member for insulation, heat transfer, or the like exists between the two target objects. “Attachment hole” is not limited to a hole having a screw groove, and may be a hole having no screw groove. “Parallel”, “orthogonal”, or “the same” may include “substantially parallel”, “substantially orthogonal”, or “substantially the same”, respectively.

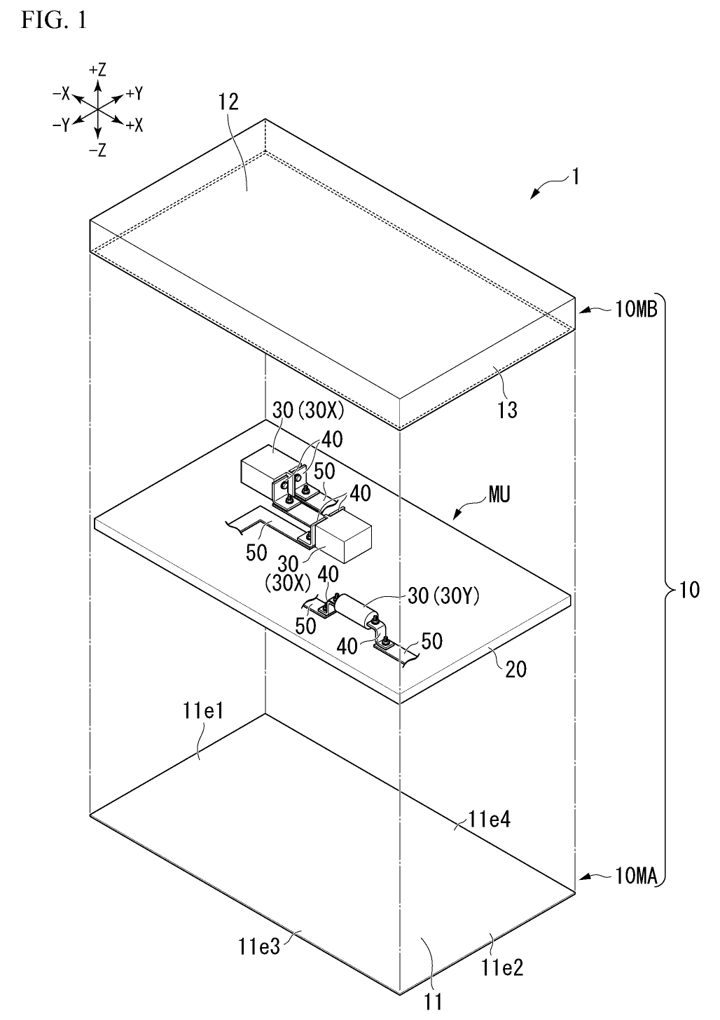

In the present disclosure, a +X direction, a -X direction, a +Y direction, a -Y direction, a +Z direction, and a -Z direction are defined as described below. The +X direction is, for example, a direction from a first end portion 11e1 to a second end portion 11e2 of a lower wall 11 of an enclosure 10 that will be described later (see FIG. 1). The -X direction is a direction opposite to the +X direction. Hereinafter, the +X direction and the -X direction are simply referred to as an “X direction” when they are not distinguished from each other. The +Y direction and the -Y direction are directions intersecting (for example, orthogonal to) the X direction. The +Y direction is, for example, a direction from a third end portion 11e3 to a fourth end portion 11e4 of the lower wall 11 of the enclosure 10 that will be described later (see FIG. 1). The -Y direction is a direction opposite to the +Y direction. Hereinafter, the +Y direction and the -Y direction are simply referred to as a “Y direction” when they are not distinguished from each other. The +Z direction and the -Z direction are directions intersecting (for example, orthogonal to) the X direction and the Y direction. The +Z direction is a direction from a lower wall 11 of the enclosure 10 that will be described later toward a main body MU (see FIG. 1). The -Z direction is a direction opposite to the +Z direction. Hereinafter, in a case where the +Z direction and the -Z direction are not distinguished from each other, the directions will be simply referred to as “Z direction”.

In the following description, when the X direction and the Y direction are not distinguished from each other, they may be referred to as a “horizontal direction”. The Z direction may be referred to as a "vertical direction". The +Z direction side may be referred to as "upper", and the -Z direction side may be referred to as "lower". However, these expressions are expressions for convenience of description, and do not limit a gravity direction of an electrical connection unit 1 (an installation posture of the electrical connection unit 1).

The ordinal numbers such as "first..." and "second..." in the present disclosure are used for convenience of distinction. That is, ordinal numbers such as "first..." and "second..." attached to each member or each portion may be appropriately reattached according to a target content or viewpoint.

### Embodiment

### 1. Basic Structure of Electrical Connection Unit

### 1.1 Overall Structure of Electrical Connection Unit

First, an overall structure of the electrical connection unit 1 will be described.

FIG. 1 is a partially exploded perspective view of the electrical connection unit 1 of the embodiment. The electrical connection unit 1 is, for example, an in-vehicle device mounted on a vehicle such as an electric vehicle (EV), a hybrid electric vehicle (HEV), or a plug-in hybrid electric vehicle (PHEV). For example, the electrical connection unit 1 may be referred to as an “electrical connection box” or a “junction box”. However, the electrical connection unit 1 is not limited to a box-shaped device. The electrical connection unit 1 includes, for example, the enclosure 10 and the main body MU.

### Enclosure

The enclosure 10 is a member forming the exterior of the electrical connection unit 1. The enclosure 10 has, for example, a box shape. The enclosure 10 is made of, for example, synthetic resin and has an insulating property. The enclosure 10 accommodates the main body MU. The enclosure 10 includes, for example, the lower wall 11, an upper wall 12, and a peripheral wall 13. The lower wall 11 covers at least a part of the main body MU from below. The upper wall 12 covers at least a part of the main body MU from above. The peripheral wall 13 surrounds the periphery of the main body MU.

The enclosure 10 includes, for example, a first member 10MA including the lower wall 11 and a second member 10MB including the upper wall 12 and the peripheral wall 13. In the present embodiment, the enclosure 10 is formed by combining the first member 10MA and the second member 10MB. Note that the lower wall 11 may be formed of an insulating sheet or the like instead of the wall having rigidity. A part or the whole of the enclosure 10 may be omitted.

### Main Body

The main body MU is a portion that performs a main function (for example, switching of electrical connection states or overcurrent protection) of the electrical connection unit 1. The main body MU may be referred to as a “circuit constitution body”. The main body MU includes, for example, a base member 20, a plurality of electronic components 30, a plurality of connection components 40, and a plurality of bus bars 50.

### 1.2 Base Member

First, the base member 20 will be described. The base member 20 is a member that supports one or more electronic components 30 and/or one or more bus bars 50 inside the enclosure 10. The base member 20 is made of, for example, synthetic resin and has an insulating property. At least a part of the base member 20 is disposed in the Z direction between the one or more electronic components 30 and/or the one or more bus bars 50, and the lower wall 11 of the enclosure 10. The base member 20 is fixed to the lower wall 11 of the enclosure 10, for example. The base member 20 supports the one or more electronic components 30 and/or the one or more bus bars 50 from below. The base member 20 may be, for example, a wall portion provided along the horizontal direction, a structure in which a plurality of ribs standing in the vertical direction is combined, or the like. The base member 20 may be formed of a part of the enclosure 10.

### 1.3 Electronic Component

Next, the electronic component 30 will be described. The electronic component 30 is an electronic component mounted in accordance with a function required for the main body MU. The electronic component 30 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. However, the type of the electronic component 30 is not limited to the above example. The electronic component 30 is, for example, a heat generating component that generates heat at the time of energization.

The electrical connection unit 1 includes, for example, a first-type electronic component 30X and a second-type electronic component 30Y as the electronic components 30. Note that the electrical connection unit 1 does not need to include both the electronic component 30X and the electronic component 30Y, and may include only one of the electronic component 30X and the electronic component 30Y. Hereinafter, in a case where the electronic component 30X and the electronic component 30Y are not distinguished from each other, they are simply referred to as an “electronic component 30”.

### 1.3.1 First-Type Electronic Component

First, the first-type electronic component 30X will be described.

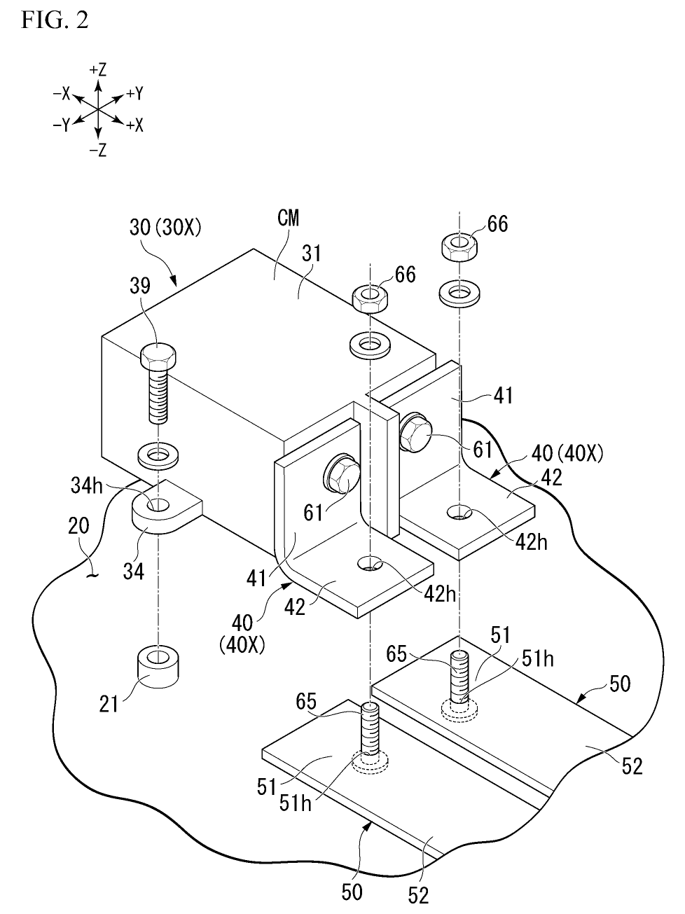

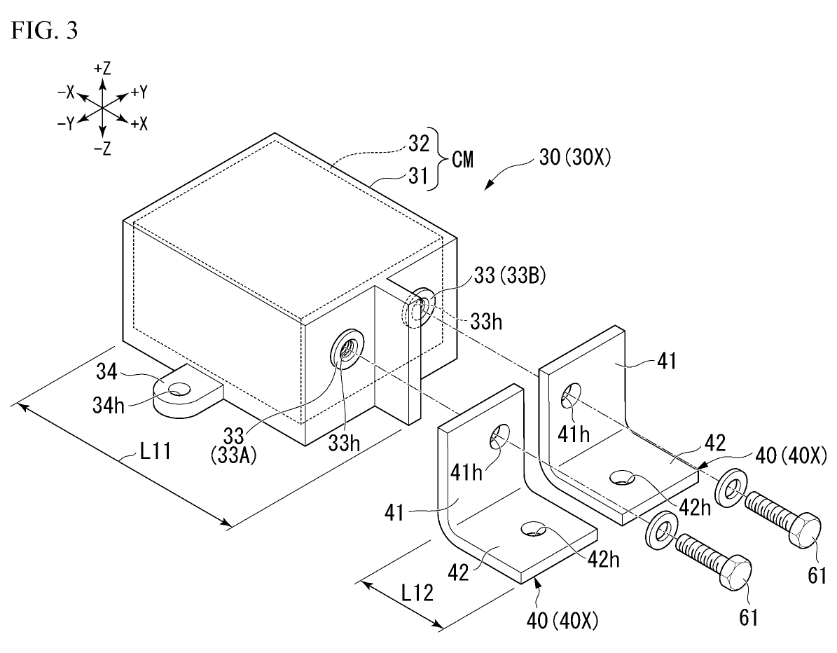

FIG. 2 is a perspective view showing the first-type electronic component 30X. The electronic component 30X includes, for example, a case 31, an electrical function portion 32 (see FIG. 3), a plurality of terminals 33 (see FIG. 3), and an attachment portion 34. Hereinafter, the case 31 and the electrical function portion 32 are collectively referred to as a "component body CM".

### Case

The case 31 is an outer frame member that forms most of the outer frame of the electronic component 30. The case 31 is made of, for example, synthetic resin and has an insulating property. The case 31 accommodates the electrical function portion 32. Note that the case 31 and the electrical function portion 32 may be integrally formed.

### Electrical Function Portion

FIG. 3 is a further partially exploded perspective view of the structure illustrated in FIG. 2. The electrical function portion 32 is a portion that performs a main function of the electronic component 30. For example, in a case where the electronic component 30 is a relay, the electrical function portion 32 includes a switch portion (for example, a contact portion) that switches between a conductive state and a non-conductive state. For example, in a case where the electronic component 30 is a fuse, the electrical function portion 32 includes a fusible portion that melts when an overcurrent flows. For example, in a case where the electronic component 30 is a capacitor, the electrical function portion 32 includes a power storage portion that accumulates electric charges.

### Terminal

The terminal 33 is an electrical connection portion exposed to the outside of the case 31. The terminal 33 is electrically connected to the electrical function portion 32 inside the case 31. In the present embodiment, the electronic component 30 includes a terminal 33A and a terminal 33B as the plurality of terminals 33. One of the terminal 33A and the terminal 33B is a positive electrode terminal. The other of the terminal 33A and the terminal 33B is a negative electrode terminal.

In the first-type electronic component 30X, the terminal 33A and the terminal 33B are provided at one end portion of the electronic component 30X in the horizontal direction (for example, the X direction). The terminal 33A and the terminal 33B are adjacent to each other in the horizontal direction (for example, the Y direction). The terminal 33A and the terminal 33B face the horizontal direction (for example, the X direction).

Each terminal 33 has an attachment hole 33h into which a fastening member 61 (for example, a screw or a bolt) to be described later is inserted. The attachment hole 33h is open in the horizontal direction (for example, the X direction). In the example illustrated in FIG. 3, the attachment hole 33h is open in the +X direction, and the fastening member 61 is inserted from the +X direction side. An inner circumferential surface of the attachment hole 33h has a screw groove. The attachment hole 33h is an engagement hole provided in the electronic component 30X.

### Attachment Portion

The attachment portion 34 is a projecting portion used for fixing the electronic component 30X. For example, the attachment portion 34 is placed, from the Z direction, on a fixing portion 21 (for example, a boss; see FIG. 2) provided on the base member 20. The attachment portion 34 has an attachment hole 34h into which a fastening member 39 (for example, a screw or a bolt) is inserted. The attachment hole 34h is open in the Z direction. The fastening member 39 that has passed through the attachment hole 34h is fixed to the fixing portion 21 of the base member 20, and thus the attachment portion 34 is attached to the base member 20. The electronic component 30X is fixed to the base member 20 by the attachment portion 34 being attached to the base member 20.

### 1.3.2 Second-Type Electronic Component

Next, the second-type electronic component 30Y will be described.

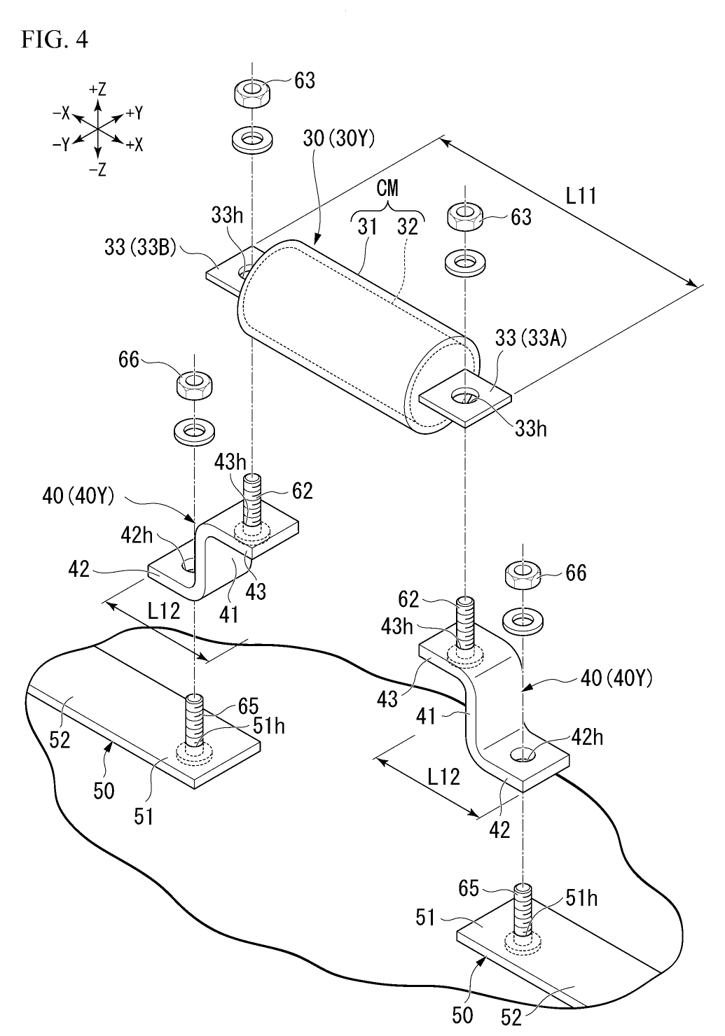

FIG. 4 is a perspective view showing the second-type electronic component 30Y. The electronic component 30Y includes, for example, a case 31, an electrical function portion 32, and a plurality of terminals 33. The case 31 and the electrical function portion 32 of the electronic component 30Y are similar to the case 31 and the electrical function portion 32 of the electronic component 30X described above, and thus redundant description is omitted.

### Terminal

A terminal 33A and a terminal 33B of the electronic component 30Y are disposed separately at both end portions of the electronic component 30Y in the horizontal direction (in the example illustrated in FIG. 4, the X direction). The terminal 33A and the terminal 33B are adjacent to each other in the horizontal direction (in the example illustrated in FIG. 3, the X direction) with the component body CM interposed therebetween. The terminals 33 protrude from the case 31 in the horizontal direction. The terminals 33 are metal plate portions provided along the X direction and the Y direction. Each terminal 33 has an attachment hole 33h into which a fastening member 62 (for example, a screw or a bolt) to be described later is inserted. The attachment hole 33h is a through-hole penetrating the terminal 33 in the Z direction.

### 1.4 Connection Component

Next, the connection component 40 will be described. The connection component 40 is a component that is disposed between the electronic component 30 and the routing member (for example, the bus bar 50) and electrically connects the electronic component 30 and the routing member. The connection component 40 forms a part of a conductive path in the electrical connection unit 1. The connection component 40 is a metal member made of, for example, copper, a copper alloy, aluminum, or an aluminum alloy. In the present embodiment, a length L12 of the connection component 40 in a longitudinal direction (for example, the X direction) of the electronic component 30 is smaller than a length L11 of the electronic component 30 in the longitudinal direction (see FIGS. 3 and 4).

Note that, in the present disclosure, the phrase “the connection component is disposed between the electronic component and the routing member” is not limited to a case where a part of the connection component is located between the electronic component and the routing member (for example, the bus bar) when viewed from the X direction or the Y direction. The phrase “the connection component is disposed between the electronic component and the routing member” may correspond to a case where a part of the connection component is located between the electronic component and the routing member (for example, the bus bar) when viewed from a direction inclined with respect to the X direction or the Y direction.

The electrical connection unit 1 includes, as the connection components 40, for example, a first-type connection component 40X corresponding to the electronic component 30X and a second-type connection component 40Y corresponding to the electronic component 30Y. Note that the electrical connection unit 1 does not need to include both the connection component 40X and the connection component 40Y, and may include only one of the connection component 40X and the connection component 40Y. Hereinafter, in a case where the connection component 40X and the connection component 40Y are not distinguished from each other, they are simply referred to as a “connection component 40”. In addition, the electronic component 30 may be directly connected to the routing member (for example, the bus bar 50) without the connection component 40 interposed therebetween.

### 1.4.1 First-Type Connection Component

First, the first-type connection component 40X will be described.

As illustrated in FIG. 3, the connection component 40X is adjacent to the electronic component 30X in the horizontal direction (for example, the X direction). For example, the connection component 40X is adjacent to the component body CM of the electronic component 30X in the horizontal direction (for example, the X direction). The connection component 40X includes, for example, a first portion 41 and a second portion 42.

### First Portion

The first portion 41 of the connection component 40X is a portion connected to the terminal 33 of the electronic component 30X. The first portion 41 extends in the Z direction along one end portion (for example, an end portion in the X direction) of the electronic component 30X. For example, the first portion 41 is a plate portion provided along the Z direction and the Y direction. The first portion 41 is a standing portion that stands in the Z direction with respect to the bus bar 50. The first portion 41 is adjacent to the terminal 33 of the electronic component 30X in the horizontal direction (for example, the X direction), and is connected to the terminal 33 of the electronic component 30X from the horizontal direction (for example, the X direction).

The first portion 41 of the connection component 40X has an attachment hole 41h through which the fastening member 61 (for example, a screw or a bolt) passes. The attachment hole 41h is open in the horizontal direction (for example, the X direction). The attachment hole 41h faces the attachment hole 33h of the terminal 33 of the electronic component 30X. The first portion 41 is physically and electrically connected to the terminal 33 of the electronic component 30X when the fastening member 61 that has passed through the attachment hole 41h is engaged with the attachment hole 33h of the terminal 33 of the electronic component 30X.

### Second Portion

The second portion 42 of the connection component 40X is a portion connected to the bus bar 50 (see FIG. 2) described later. The second portion 42 extends in the horizontal direction (for example, the X direction) from one end portion of the first portion 41 in the Z direction (for example, an end portion on the -Z direction side). The second portion 42 is a plate portion provided along the X direction and the Y direction. The second portion 42 is adjacent to the bus bar 50 in the Z direction, and is connected to the bus bar 50 from the Z direction.

The second portion 42 of the connection component 40X has an attachment hole 42h through which a fastening member 65 (see FIG. 2) described later passes. The attachment hole 42h is a through-hole penetrating the second portion 42 in the Z direction. The second portion 42 is fixed to the bus bar 50 by engaging an engagement member 66 (for example, a nut) with a tip portion of the fastening member 65 that has passed through the attachment hole 42h (see FIG. 2).

In the present embodiment, the first portion 41 and the second portion 42 form one L-shaped connection component 40X. In the present embodiment, the connection component 40X including the first portion 41 and the second portion 42 is formed by bending one metal plate.

### 1.4.2 Second-Type Connection Component

Next, the second-type connection component 40Y will be described.

As illustrated in FIG. 4, the connection component 40Y is adjacent to the component body CM of the electronic component 30Y in the horizontal direction (for example, the X direction). The connection component 40Y includes, for example, a first portion 41, a second portion 42, and a third portion 43.

### First Portion

The first portion 41 of the connection component 40Y is a standing portion that stands in the Z direction with respect to the bus bar 50. For example, the first portion 41 is a plate portion provided along the Z direction and the Y direction. The first portion 41 is electrically connected to the terminal 33 of the electronic component 30Y via the third portion 43 described later.

### Second Portion

The second portion 42 of the connection component 40Y is a portion connected to the bus bar 50. Details of the second portion 42 of the connection component 40Y are similar to the details of the second portion 42 of the connection component 40X.

### Third Portion

The third portion 43 of the connection component 40Y is a portion connected to the terminal 33 of the electronic component 30Y. The third portion 43 extends in the horizontal direction (for example, the X direction) from the other end portion of the first portion 41 in the Z direction (for example, an end portion on the +Z direction side). For example, the third portion 43 is a plate portion provided along the X direction and the Y direction. The third portion 43 is adjacent to the terminal 33 of the electronic component 30Y in the Z direction, and is connected to the terminal 33 of the electronic component 30Y from the Z direction.

The third portion 43 of the connection component 40Y has an attachment hole 43h through which the fastening member 62 passes. The attachment hole 43h is a through-hole penetrating the third portion 43 in the Z direction. The fastening member 62 passes through the attachment hole 43h and protrudes from the third portion 43 of the connection component 40Y to one side in the Z direction (for example, the +Z direction side). The fastening member 62 passes through the attachment hole 33h of the electronic component 30Y. Then, an engagement member 63 (for example, a nut) is engaged with a tip portion of the fastening member 62 that has passed through the attachment hole 43h of the connection component 40Y and the attachment hole 33h of the electronic component 30Y, and thus the third portion 43 is physically and electrically connected to the terminal 33 of the electronic component 30Y. The fastening member 62 is, for example, a caulking bolt fixed to the third portion 43 of the connection component 40Y. Note that the fastening member 62 is not limited to a caulking bolt, and may be a general bolt or screw.

In the present embodiment, the first portion 41, the second portion 42, and the third portion 43 form one connection component 40Y. In the present embodiment, the connection component 40Y including the first portion 41, the second portion 42, and the third portion 43 is formed by bending one metal plate.

### 1.5 Bus Bar

Next, the bus bar 50 will be described with reference to FIGS. 2 and 4. The bus bar 50 is a member for forming a conductive path in the electrical connection unit 1. The bus bar 50 extends between a plurality of connection target components and electrically connects the plurality of connection target components. The "connection target component" is, for example, the electronic component 30, the connection component 40, another bus bar 50, or a bus bar for external connection. However, the connection target component is not limited to the above examples. The bus bar 50 is made of a metal member (for example, a metal plate), for example, copper, a copper alloy, aluminum, or an aluminum alloy. The bus bar 50 is an example of the “routing member”. The bus bar 50 includes, for example, a plurality of connection portions 51 and one or more extension portions 52.

### Connection Portion

The connection portion 51 is a portion connected to the connection target component. The connection portion 51 overlaps at least a part of the connection target component and is electrically connected to the connection target component, for example, when viewed from the Z direction. The connection portion 51 has a plate shape along the X direction and the Y direction, for example. The connection portion 51 has an attachment hole 51h through which the fastening member 65 passes. The attachment hole 51h is a through-hole penetrating the connection portion 51 in the Z direction. The fastening member 65 passes through the attachment hole 51h and protrudes from the connection portion 51 to one side in the Z direction (for example, the +Z direction side). The fastening member 65 passes through an attachment hole of the connection target component (for example, the attachment hole 42h of the connection component 40). The engagement member 66 (for example, a nut) is engaged with the tip portion of the fastening member 65 passed through the attachment hole 51h of the connection portion 51 and the attachment hole of the connection target component, so that the connection portion 51 is physically and electrically connected to the connection target component. The fastening member 65 is, for example, a caulking bolt fixed to the connection portion 51. Note that the fastening member 65 is not limited to a caulking bolt, and may be a general bolt or screw.

### Extension Portion

The extension portion 52 is provided between two adjacent connection portions 51, and extends so as to connect the two connection portions 51. The extension portion 52 has a plate shape along the X direction and the Y direction, for example. Note that the extension portion 52 may have a bent portion bent in the Z direction.

### 2. Aspect of Electrical Connection Unit

Next, an aspect of the electrical connection unit 1 will be described.

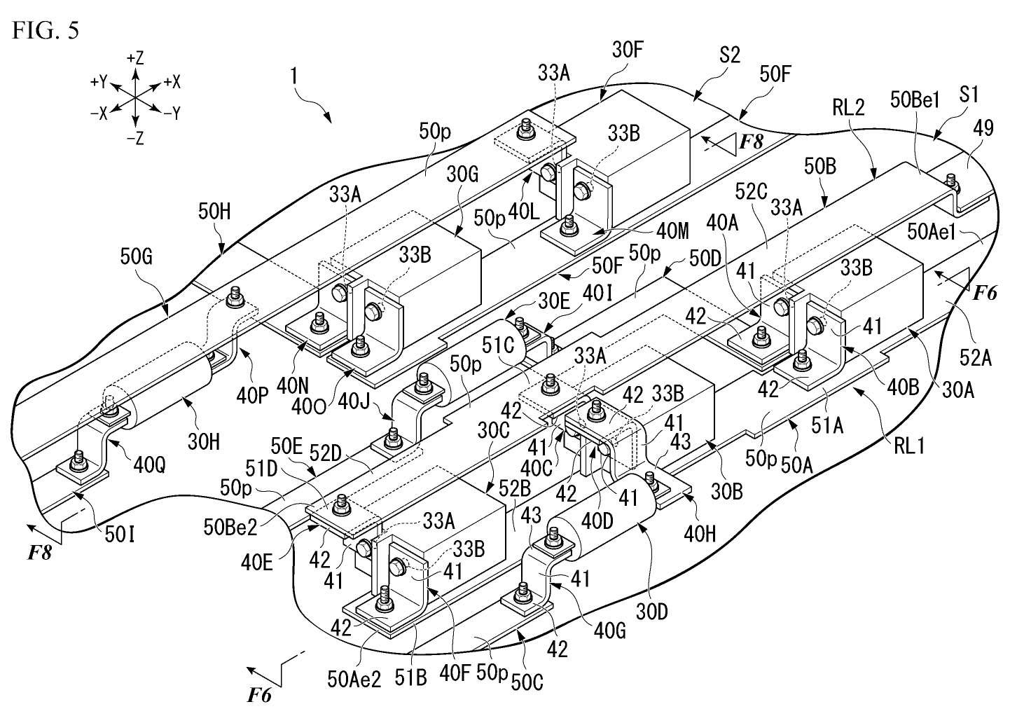

FIG. 5 is a perspective view illustrating an aspect of the electrical connection unit 1. The electrical connection unit 1 of the present embodiment includes a constitution related to a first viewpoint to be described later and a constitution related to a second viewpoint to be described later. Note that the electrical connection unit 1 may have only one of the constitution related to the first viewpoint and the constitution related to the second viewpoint.

### 3. Constitution Related to First Viewpoint

First, the constitution related to the first viewpoint will be described. The constitution related to the first viewpoint is a constitution related to a two-layer structure of the plurality of bus bars 50. The electrical connection unit 1 includes, for example, a first structure S1 and a second structure S2.

### 3.1 First Structure

First, the first structure S1 will be described. The first structure S1 includes, for example, an electronic component 30A, an electronic component 30B, an electronic component 30C, an electronic component 30D, and an electronic component 30E as the plurality of electronic components 30. The first structure S1 includes, for example, a connection component 40A, a connection component 40B, a connection component 40C, a connection component 40D, a connection component 40E, a connection component 40F, a connection component 40G, a connection component 40H, a connection component 40I, and a connection component 40J as the plurality of connection components 40. The first structure S1 includes, for example, a bus bar 50A, a bus bar 50B, a bus bar 50C, a bus bar 50D, and a bus bar 50E as the plurality of bus bars 50.

### 3.1.1 Electronic Component and Connection Component of First Structure

Each of the electronic component 30A, the electronic component 30B, and the electronic component 30C is the first-type electronic component 30X described above. The electronic component 30A, the electronic component 30B, and the electronic component 30C are disposed side by side in the X direction, and at least partially overlap each other when viewed from the X direction. The electronic component 30A, the electronic component 30B, and the electronic component 30C are arranged on a straight line, for example. Each of the connection component 40A, the connection component 40B, the connection component 40C, the connection component 40D, the connection component 40E, and the connection component 40F is the first-type connection component 40X described above.

On the other hand, each of the electronic component 30D and the electronic component 30E is the second-type electronic component 30Y described above. Each of the connection component 40G, the connection component 40H, the connection component 40I, and the connection component 40J is the second-type connection component 40Y described above.

### Electronic Component 30A and Connection Components 40A and 40B

The electronic component 30A is disposed on the most +X direction side among the three electronic components 30A, 30B, and 30C. The two terminals 33A and 33B of the electronic component 30A are adjacent to each other in the Y direction and face the same direction. The two terminals 33A and 33B of the electronic component 30A face the X direction (for example, the -X direction). Note that the electronic component 30A may be disposed with the terminals 33A and 33B facing the +X direction. The connection component 40A is connected to the terminal 33A of the electronic component 30A. The connection component 40B is connected to the terminal 33B of the electronic component 30A. From the first viewpoint, the electronic component 30A is an example of the “first electronic component”. The terminal 33B of the electronic component 30A is an example of the “first terminal”. The terminal 33A of the electronic component 30A is an example of the “second terminal”.

The connection component 40A and the connection component 40B are adjacent to the component body CM (see FIG. 3) of the electronic component 30A in the X direction. Each of the connection component 40A and the connection component 40B is disposed in a first posture with respect to the first-type connection component 40X. The first posture is a posture in which the second portion 42 is located on the -Z direction side with respect to the first portion 41 of the connection component 40X. That is, the second portion 42 of each of the connection component 40A and the connection component 40B faces the -Z direction. From the first viewpoint, the connection component 40B is an example of the “first connection component”.

### Electronic Component 30B and Connection Components 40C and 40D

The electronic component 30B is disposed at the center among the three electronic components 30A, 30B, and 30C. The electronic component 30B is adjacent to the electronic component 30A in the X direction. The two terminals 33A and 33B of the electronic component 30B are adjacent to each other in the Y direction and face the same direction. The two terminals 33A and 33B of the electronic component 30B face the X direction (for example, the -X direction). Note that the electronic component 30B may be disposed with the terminals 33A and 33B facing the +X direction. The connection component 40C is connected to the terminal 33A of the electronic component 30B. The connection component 40D is connected to the terminal 33B of the electronic component 30B. From the first viewpoint, the electronic component 30B is an example of the “second electronic component”. The terminal 33A of the electronic component 30B is an example of a “third terminal”. The terminal 33B of the electronic component 30B is an example of a “fourth terminal”.

The connection component 40C and the connection component 40D are adjacent to the component body CM (see FIG. 3) of the electronic component 30B in the X direction. Each of the connection component 40C and the connection component 40D is disposed in a second posture with respect to the first-type connection component 40X. The second posture is a posture different from the first posture. The second posture is a posture in which the second portion 42 is located on the +Z direction side with respect to the first portion 41 of the connection component 40X. That is, the second posture is a posture vertically opposite to the first posture. The second portion 42 of each of the connection component 40C and the connection component 40D faces the +Z direction. From the first viewpoint, the connection component 40C is an example of a “second connection component”.

### Electronic Component 30C and Connection Components 40E and 40F

The electronic component 30C is disposed on the most -X direction side among the three electronic components 30A, 30B, and 30C. In other words, the electronic component 30C is located on the side opposite to the electronic component 30A relative to the electronic component 30B. The two terminals 33A and 33B of the electronic component 30C are arranged in the Y direction and face the same direction. The two terminals 33A and 33B of the electronic component 30C face the X direction (for example, the -X direction). Note that the electronic component 30C may be disposed with the terminals 33A and 33B facing the +X direction. The connection component 40E is connected to the terminal 33A of the electronic component 30C. The connection component 40F is connected to the terminal 33B of the electronic component 30C. From the first viewpoint, the electronic component 30C is an example of a “third electronic component”. The terminal 33B of the electronic component 30C is an example of a “fifth terminal”. The terminal 33A of the electronic component 30C is an example of a “sixth terminal”.

The connection component 40E and the connection component 40F are adjacent to the component body CM (see FIG. 3) of the electronic component 30C in the X direction. The connection component 40E is disposed in the second posture. That is, the second portion 42 of the connection component 40E faces the +Z direction. On the other hand, the connection component 40F is disposed in the first posture. That is, the second portion 42 of the connection component 40F faces the -Z direction. This content will be described later in detail as the second viewpoint.

### Electronic Component 30D and Connection Components 40G and 40H

The terminal 33A and the terminal 33B of the electronic component 30D are adjacent to each other in the X direction with the component body CM (see FIG. 4) of the electronic component 30D interposed therebetween. The connection component 40G is connected to the terminal 33A of the electronic component 30D. The connection component 40G is adjacent to the component body CM of the electronic component 30D in the X direction. The connection component 40G is disposed in the first posture with respect to the second-type connection component 40Y. The first posture is a posture in which the second portion 42 is located on the -Z direction side with respect to the first portion 41 of the connection component 40Y. The second portion 42 of the connection component 40G disposed in the first posture faces the -Z direction. The third portion 43 of the connection component 40G is connected to the terminal 33A of the electronic component 30D.

On the other hand, the connection component 40H is connected to the terminal 33B of the electronic component 30D. The connection component 40H is adjacent to the component body CM of the electronic component 30D in the X direction. The connection component 40H is disposed in the second posture with respect to the second-type connection component 40Y. The second posture is a posture different from the first posture. The second posture is a posture in which the second portion 42 is located on the +Z direction side with respect to the first portion 41 of the connection component 40Y. That is, the second posture is a posture vertically opposite to the first posture. The second portion 42 of the connection component 40H disposed in the second posture faces the +Z direction. The third portion 43 of the connection component 40H is connected to the terminal 33B of the electronic component 30D.

### Electronic Component 30E and Connection Components 40I and 40J

The connection component 40I is connected to the terminal 33A of the electronic component 30E. The connection component 40J is connected to the terminal 33B of the electronic component 30E. Each of the connection component 40I and the connection component 40J is disposed, for example, in the first posture.

### 3.1.2 Bus Bar of First Structure

Next, the bus bar 50 included in the first structure S1 will be described. In the present embodiment, the electrical connection unit 1 includes a lower routing layer RL1 and an upper routing layer RL2. The lower routing layer RL1 is a routing layer disposed on the -Z direction side with respect to the plurality of electronic components 30A, 30B, 30C, 30D, and 30E. On the other hand, the upper routing layer RL2 is a routing layer disposed on the +Z direction side with respect to the plurality of electronic components 30A, 30B, 30C, 30D, and 30E.

Note that, in the present disclosure, “disposed on the first side in the third direction” means which is located on the first side when viewed from the positional relationship in the third direction between the two target objects, and is not limited to the case where the two target objects overlap when viewed from the third direction. That is, "disposed on the first side in the third direction" means that the two target objects may be disposed to be misaligned from each other when viewed from the third direction and may not overlap each other. Similarly, in the present disclosure, “disposed on the second side in the third direction” means which is located on the second side when viewed from the positional relationship in the third direction between the two target objects, and is not limited to the case where the two target objects overlap when viewed from the third direction. That is, "disposed on the second side in the third direction" means that the two target objects may be disposed to be misaligned from each other when viewed from the third direction and may not overlap each other.

### Bus Bar 50A

First, the bus bar 50A will be described with reference to FIG. 5. The bus bar 50A is, for example, a routing member that electrically connects the terminal 33B of the electronic component 30A, the terminal 33B of the electronic component 30C, and another portion of the electrical connection unit 1. The bus bar 50A has a plate portion 50p. The plate portion 50p of the bus bar 50A has a plate shape along the X direction and the Y direction. From the first viewpoint, the bus bar 50A is an example of the "first routing member". The plate portion 50p of the bus bar 50A is an example of the "first plate portion".

In the present embodiment, the plate portion 50p of the bus bar 50A extends in the X direction. The plate portion 50p of the bus bar 50A has a first end portion 50Ae1 and a second end portion 50Ae2 located on a side opposite to the first end portion 50Ae1 as a pair of end portions in the X direction. The first end portion 50Ae1 is an end portion on the +X direction side. For example, the first end portion 50Ae1 is located on the +X direction side with respect to the electronic component 30A. The second end portion 50Ae2 is an end portion on the -X direction side.

The plate portion 50p of the bus bar 50A includes, for example, a connection portion 51A connected to the connection component 40B and a connection portion 51B connected to the connection component 40F as the plurality of connection portions 51. In the present embodiment, the connection portion 51B is provided at the second end portion 50Ae2 of the plate portion 50p. On the other hand, the connection portion 51A is located between the first end portion 50Ae1 and the second end portion 50Ae2 of the plate portion 50p (that is, between the first end portion 50Ae1 and another connection portion 51B). In addition, the plate portion 50p of the bus bar 50A includes, for example, an extension portion 52A extending between the first end portion 50Ae1 and the connection portion 51A and an extension portion 52B extending between the connection portion 51A and the connection portion 51B as the plurality of extension portions 52.

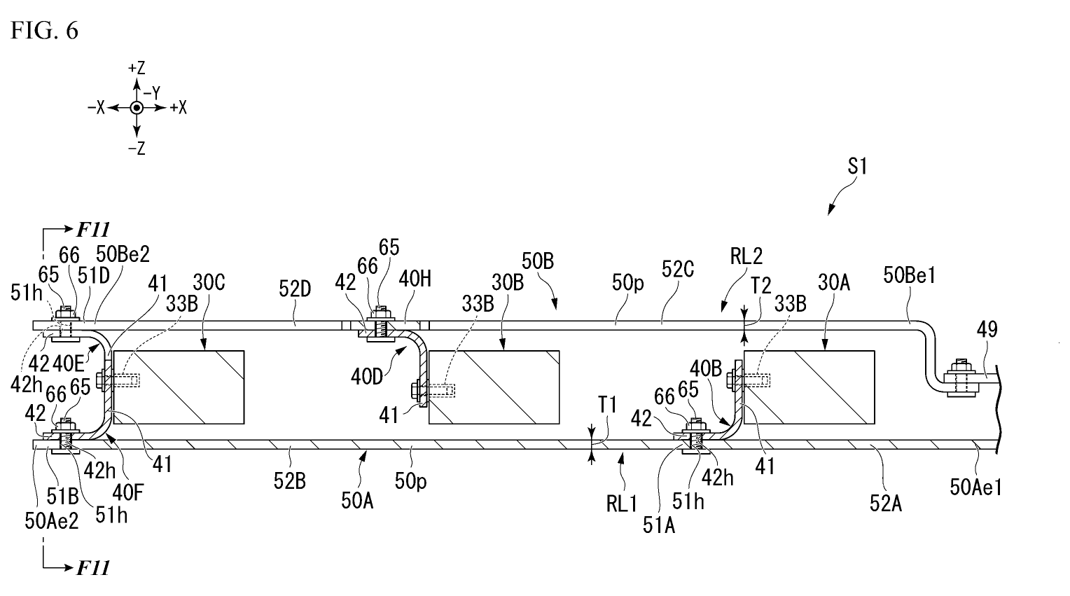

FIG. 6 is a cross-sectional view taken along line F6-F6 of the structure illustrated in FIG. 5. The plate portion 50p of the bus bar 50A is included in the lower routing layer RL1. The plate portion 50p of the bus bar 50A is disposed, for example, on the -Z direction side with respect to the plurality of electronic components 30A, 30B, and 30C.

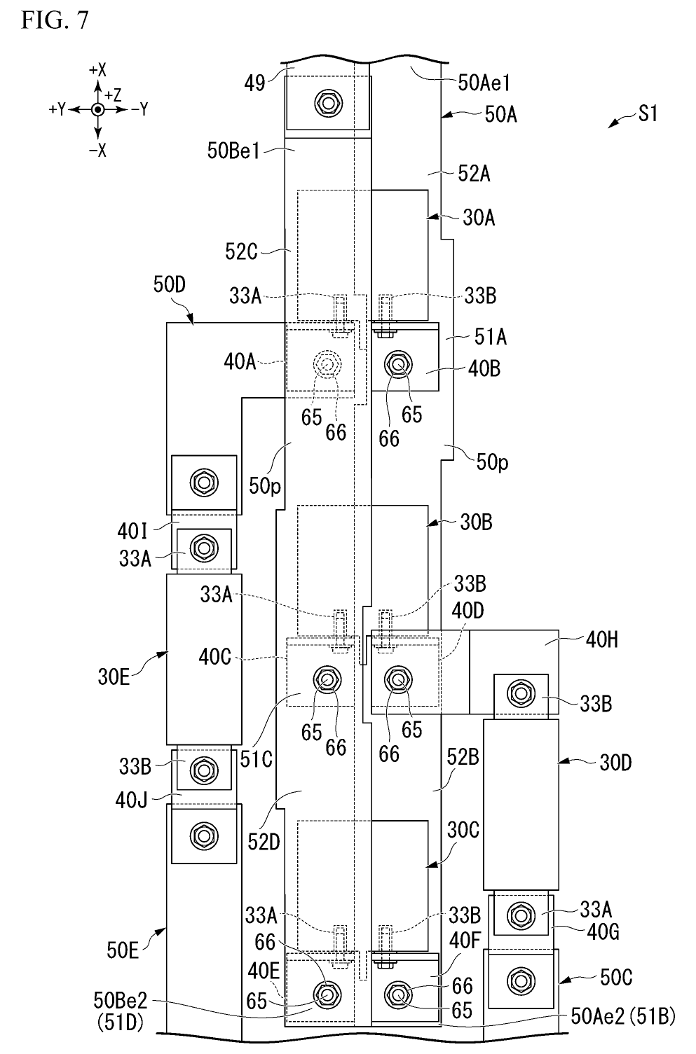

FIG. 7 is a plan view illustrating the first structure S1. The plate portion 50p of the bus bar 50A extends linearly in the X direction. Note that, in the present disclosure, the term "linear" may also correspond to a case where there is a small bent portion or the like for avoiding interference with another member. The plate portion 50p of the bus bar 50A overlaps at least one of the electronic component 30A or the connection component 40B, at least one of the electronic component 30B or the connection component 40D, and at least one of the electronic component 30C or the connection component 40F when viewed from the Z direction.

In the present embodiment, the connection portion 51A of the bus bar 50A overlaps at least the connection component 40B when viewed from the Z direction, and is physically and electrically connected to the connection component 40B from the -Z direction side. The connection portion 51A is electrically connected to the terminal 33B of the electronic component 30A via the connection component 40B. In the present embodiment, the plate portion 50p of the bus bar 50A also overlaps the electronic component 30A in addition to the connection component 40B when viewed from the Z direction. That is, the plate portion 50p (for example, the extension portion 52A) of the bus bar 50A passes under the electronic component 30A and extends in the X direction.

The plate portion 50p of the bus bar 50A overlaps the connection component 40D and the electronic component 30B when viewed from the Z direction. That is, the plate portion 50p (for example, the extension portion 52B) of the bus bar 50A passes under the electronic component 30B and extends in the X direction.

The connection portion 51B of the bus bar 50A overlaps at least the connection component 40F when viewed from the Z direction, and is physically and electrically connected to the connection component 40F from the -Z direction side. The connection portion 51B is electrically connected to the terminal 33B of the electronic component 30C via the connection component 40F. In the present embodiment, the plate portion 50p of the bus bar 50A also overlaps the electronic component 30C in addition to the connection component 40F when viewed from the Z direction. That is, the plate portion 50p (for example, the extension portion 52B) of the bus bar 50A passes under the electronic component 30C and extends in the X direction.

### Bus Bar 50B

Next, referring back to FIG. 5, the bus bar 50B will be described. The bus bar 50B is, for example, a routing member that electrically connects the terminal 33A of the electronic component 30B, the terminal 33A of the electronic component 30C, and another portion (for example, a bus bar 49 for external connection) of the electrical connection unit 1. The bus bar 50B has a plate portion 50p. The plate portion 50p of the bus bar 50B has a plate shape along the X direction and the Y direction. From the first viewpoint, the bus bar 50B is an example of the "second routing member". The plate portion 50p of the bus bar 50B is an example of the "second plate portion".

In the present embodiment, between a plate thickness T2 of the plate portion 50p of the bus bar 50B and a plate thickness T1 of the plate portion 50p of the bus bar 50A, the smaller plate thickness is equal to or larger than half of the larger plate thickness (see FIG. 6). For example, the plate thickness T2 of the plate portion 50p of the bus bar 50B and the plate thickness T1 of the plate portion 50p of the bus bar 50A are the same. Note that, in the present disclosure, the "plate thickness" is a thickness in the Z direction.

In the present embodiment, the plate portion 50p of the bus bar 50B extends in the X direction. The plate portion 50p of the bus bar 50B has a first end portion 50Be1 and a second end portion 50Be2 located on a side opposite to the first end portion 50Be1 as a pair of end portions in the X direction. The first end portion 50Be1 is an end portion on the +X direction side. For example, the first end portion 50Be1 is located on the +X direction side with respect to the electronic component 30A. The second end portion 50Be2 is an end portion on the -X direction side.

In the present embodiment, the plate portion 50p of the bus bar 50B includes, for example, a connection portion 51C connected to the connection component 40C and a connection portion 51D connected to the connection component 40E as the plurality of connection portions 51. In the present embodiment, the connection portion 51D is provided at the second end portion 50Be2 of the plate portion 50p. The connection portion 51C is located between the first end portion 50Be1 and the second end portion 50Be2 of the plate portion 50p (that is, between the first end portion 50Be1 and another connection portion 51D). In addition, the plate portion 50p of the bus bar 50B includes, for example, an extension portion 52C extending between the first end portion 50Be1 and the connection portion 51C and an extension portion 52D extending between the connection portion 51C and the connection portion 51D as the plurality of extension portions 52.

The plate portion 50p of the bus bar 50B is included in the upper routing layer RL2. The plate portion 50p of the bus bar 50B is disposed, for example, on the +Z direction side with respect to the plurality of electronic components 30A, 30B, and 30C (see FIG. 6). The plate portion 50p of the bus bar 50B overlaps at least one of the electronic component 30A or the connection component 40A, at least one of the electronic component 30B or the connection component 40C, and at least one of the electronic component 30C or the connection component 40E when viewed from the Z direction (see FIG. 7). The plate portion 50p of the bus bar 50B extends in the X direction to the vicinity of the electronic component 30C with respect to the electronic component 30B when viewed from the electronic component 30A, and is electrically connected to the electronic component 30C.

As illustrated in FIG. 7, the plate portion 50p of the bus bar 50B at least partially overlaps the plate portion 50p of the bus bar 50A when viewed from the Z direction. For example, the plate portion 50p of the bus bar 50B at least partially overlaps the plate portion 50p of the bus bar 50A at a position where the electronic components 30A, 30B, and 30C and the plate portion 50p of the bus bar 50A overlap when viewed from the Z direction.

In the present embodiment, the plate portion 50p of the bus bar 50B overlaps the connection component 40A and the electronic component 30A when viewed from the Z direction. That is, the plate portion 50p (for example, the extension portion 52C) of the bus bar 50B passes above the electronic component 30A and extends in the X direction.

The connection portion 51C of the bus bar 50B overlaps at least the connection component 40C when viewed from the Z direction, and is physically and electrically connected to the connection component 40C from the +Z direction side. The connection portion 51C is electrically connected to the terminal 33A of the electronic component 30B via the connection component 40C. In the present embodiment, the plate portion 50p of the bus bar 50B also overlaps the electronic component 30B in addition to the connection component 40C when viewed from the Z direction. That is, the plate portion 50p (for example, the extension portion 52C) of the bus bar 50B passes above the electronic component 30B and extends in the X direction.

The connection portion 51D of the bus bar 50B overlaps at least the connection component 40E when viewed from the Z direction, and is physically and electrically connected to the connection component 40E from the -Z direction side. The connection portion 51D is electrically connected to the terminal 33A of the electronic component 30C via the connection component 40E. In the present embodiment, the plate portion 50p of the bus bar 50B also overlaps the electronic component 30C in addition to the connection component 40E when viewed from the Z direction. That is, the plate portion 50p (for example, the extension portion 52D) of the bus bar 50B passes above the electronic component 30C and extends in the X direction.

### Bus Bar 50C

The bus bar 50C is, for example, a routing member that electrically connects the terminal 33A of the electronic component 30D and another portion of the electrical connection unit 1. The bus bar 50C has a plate portion 50p provided along the X direction and the Y direction. The plate portion 50p of the bus bar 50C is included in the lower routing layer RL1.

### Bus Bar 50D

The bus bar 50D is, for example, a routing member that electrically connects the connection component 40A and the connection component 40I. The bus bar 50D has a plate portion 50p provided along the X direction and the Y direction. The plate portion 50p of the bus bar 50D is included in the lower routing layer RL1.

### Bus Bar 50E

The bus bar 50E is, for example, a routing member that electrically connects the connection component 40J and another portion of the electrical connection unit 1. The bus bar 50E has a plate portion 50p provided along the X direction and the Y direction. The plate portion 50p of the bus bar 50E is included in the lower routing layer RL1.

### 3.2 Second Structure

Next, the second structure S2 will be described with reference to FIG. 5. In the second structure S2, as the plurality of electronic components 30, for example, an electronic component 30F, an electronic component 30G, and an electronic component 30H include, as the plurality of connection components 40, for example, a connection component 40L, a connection component 40M, a connection component 40N, a connection component 40O, a connection component 40P, and a connection component 40Q. The second structure S2 includes, for example, a bus bar 50F, a bus bar 50G, a bus bar 50H, and a bus bar 50I as the plurality of bus bars 50.

### 3.2.1 Electronic Component and Connection Component of Second Structure

Each of the electronic component 30F and the electronic component 30G is the first-type electronic component 30X described above. The electronic component 30F and the electronic component 30G are disposed side by side in the X direction, and at least partially overlap each other when viewed from the X direction. The electronic component 30F and the electronic component 30G are arranged on a straight line, for example. Each of the connection component 40L, the connection component 40M, the connection component 40N, and the connection component 40O is the first-type connection component 40X described above.

On the other hand, the electronic component 30H is the second-type electronic component 30Y described above. Each of the connection component 40P and the connection component 40Q is the second-type connection component 40Y described above.

### Electronic Component 30F and Connection Components 40L and 40M

The electronic component 30F is disposed on the most +X direction side among the three electronic components 30F, 30G, and 30H. The two terminals 33A and 33B of the electronic component 30F are adjacent to each other in the Y direction and face the same direction. The two terminals 33A and 33B of the electronic component 30F face the X direction (for example, the -X direction). The connection component 40L is connected to the terminal 33A of the electronic component 30F. The connection component 40M is connected to the terminal 33B of the electronic component 30F. The connection component 40L and the connection component 40M are adjacent to the component body CM (see FIG. 3) of the electronic component 30F in the X direction. The connection component 40L is disposed in the second posture, for example. The connection component 40M is disposed in the first posture, for example.

### Electronic Component 30G and Connection Components 40N and 40O

The electronic component 30G is disposed at the center among the three electronic components 30F, 30G, and 30H. The electronic component 30G is adjacent to the electronic component 30F in the X direction. The two terminals 33A and 33B of the electronic component 30G are adjacent to each other in the Y direction and face the same direction. The two terminals 33A and 33B of the electronic component 30G face the X direction (for example, the -X direction). The connection component 40N is connected to the terminal 33A of the electronic component 30G. The connection component 40O is connected to the terminal 33B of the electronic component 30G. The connection component 40N and the connection component 40O are adjacent to the component body CM (see FIG. 3) of the electronic component 30G in the X direction. Each of the connection component 40N and the connection component 40O is disposed, for example, in the first posture.

### Electronic Component 30H and Connection Components 40P and 40Q

The terminal 33A and the terminal 33B of the electronic component 30H are adjacent to each other in the X direction with the component body CM (see FIG. 4) of the electronic component 30H interposed therebetween. The connection component 40P is connected to the terminal 33A of the electronic component 30H. The connection component 40Q is connected to the terminal 33B of the electronic component 30H. The connection component 40P and the connection component 40Q are adjacent to the component body CM of the electronic component 30H in the X direction. The connection component 40P is disposed in the second posture, for example. The connection component 40Q is disposed in the first posture, for example.

### 3.2.2 Bus Bar of Second Structure

### Bus Bar 50F

The bus bar 50F is, for example, a routing member that electrically connects the terminal 33B of the electronic component 30F, the terminal 33B of the electronic component 30G, and another portion of the electrical connection unit 1. The bus bar 50F has a plate portion 50p. The plate portion 50p of the bus bar 50F has a plate shape along the X direction and the Y direction.

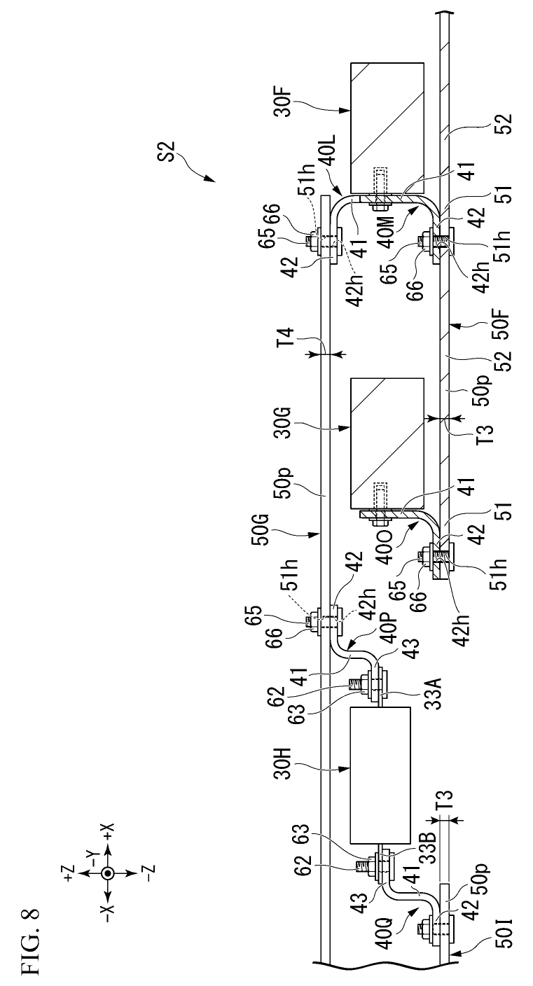

FIG. 8 is a cross-sectional view taken along line F8-F8 of the structure illustrated in FIG. 5. The plate portion 50p of the bus bar 50F is included in the lower routing layer RL1. The plate portion 50p of the bus bar 50F is disposed, for example, on the -Z direction side with respect to the plurality of electronic components 30F, 30G, and 30H.

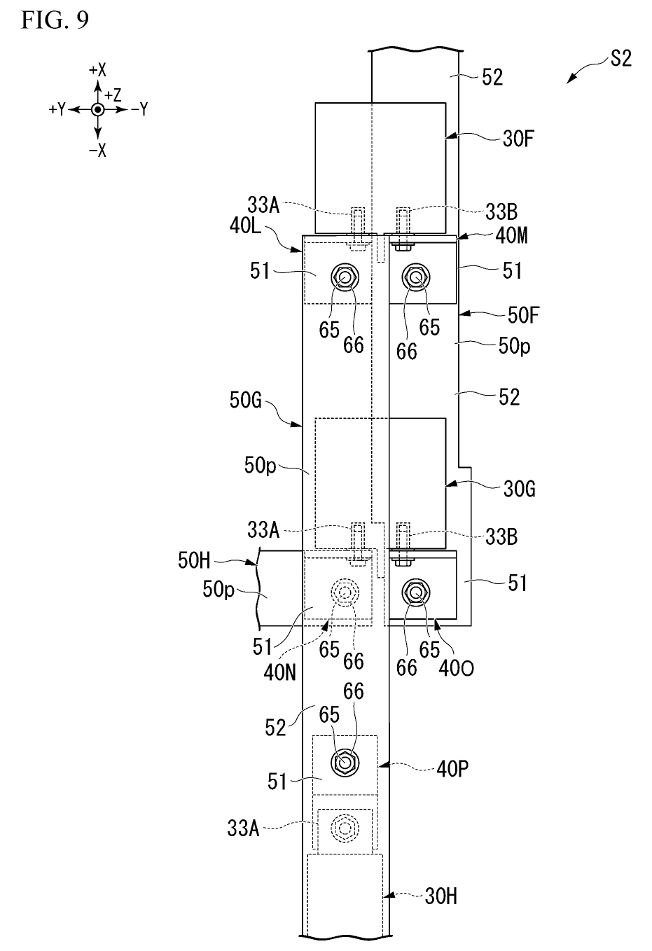

FIG. 9 is a plan view illustrating the second structure S2. The plate portion 50p of the bus bar 50F extends in the X direction. The plate portion 50p of the bus bar 50F overlaps at least one of the electronic component 30F or the connection component 40M and at least one of the electronic component 30G or the connection component 40O when viewed from the Z direction. For example, the plate portion 50p of the bus bar 50F overlaps the electronic component 30F, the connection component 40M, the electronic component 30G, and the connection component 40O when viewed from the Z direction.

### Bus Bar 50G

The bus bar 50G is, for example, a routing member that electrically connects the terminal 33A of the electronic component 30F, the terminal 33A of the electronic component 30H, and another portion of the electrical connection unit 1. The bus bar 50G has a plate portion 50p. The plate portion 50p of the bus bar 50G has a plate shape along the X direction and the Y direction. In the present embodiment, between a plate thickness T4 of the plate portion 50p of the bus bar 50G and a plate thickness T3 of the plate portion 50p of the bus bar 50F, the smaller plate thickness is equal to or larger than half of the larger plate thickness (see FIG. 8). For example, the plate thickness T4 of the plate portion 50p of the bus bar 50G and the plate thickness T3 of the plate portion 50p of the bus bar 50F are the same.

The plate portion 50p of the bus bar 50G is included in the upper routing layer RL2. The plate portion 50p of the bus bar 50G is disposed, for example, on the +Z direction side with respect to the plurality of electronic components 30F, 30G, and 30H.

The plate portion 50p of the bus bar 50G extends in the X direction. The plate portion 50p of the bus bar 50G overlaps at least one of the electronic component 30F or the connection component 40L and at least one of the electronic component 30G or the connection component 40N when viewed from the Z direction. For example, the plate portion 50p of the bus bar 50F overlaps the electronic component 30F, the connection component 40L, the electronic component 30G, the connection component 40N, the electronic component 30H, the connection component 40P, and the connection component 40Q when viewed from the Z direction.

### Bus Bar 50H

The bus bar 50H is, for example, a routing member that electrically connects the terminal 33A of the electronic component 30G and another portion of the electrical connection unit 1. The bus bar 50H has a plate portion 50p provided along the X direction and the Y direction. The plate portion 50p of the bus bar 50H is included in the lower routing layer RL1.

### Bus Bar 50I

The bus bar 50I is, for example, a routing member that electrically connects the terminal 33B of the electronic component 30H and another portion of the electrical connection unit 1. The bus bar 50I has a plate portion 50p provided along the X direction and the Y direction. The plate portion 50p of the bus bar 50I is included in the lower routing layer RL1.

### 4. Constitution Related to Second Viewpoint

Next, the constitution related to the second viewpoint will be described. The constitution related to the second viewpoint is a constitution related to a connection structure between the lower routing layer RL1 and the upper routing layer RL2.

### 4.1 Structure Using First-Type Connection Component

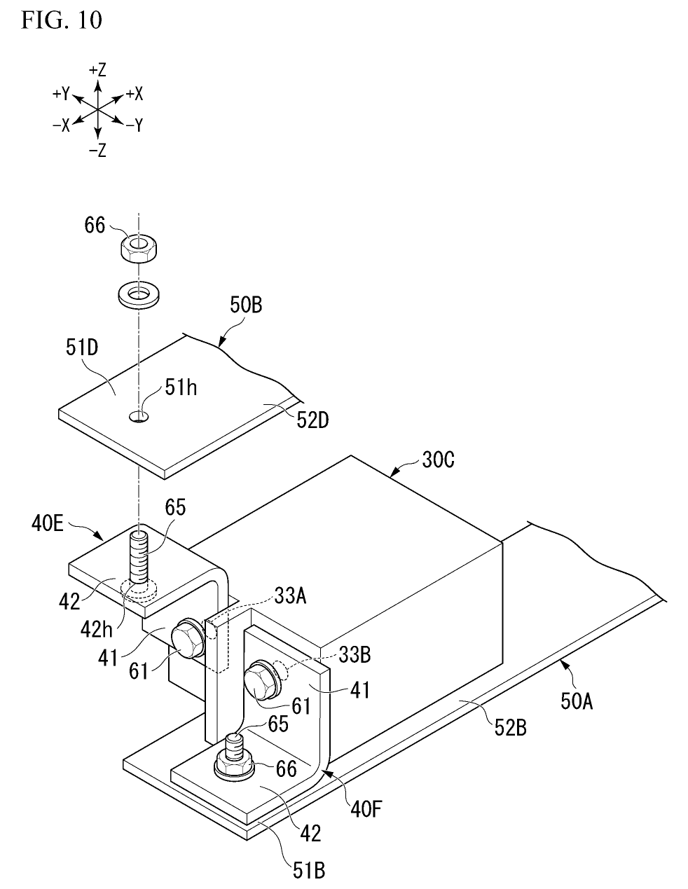

FIG. 10 is a perspective view showing a constitution related to one electronic component 30C. As described above, the bus bar 50A is disposed on the -Z direction side with respect to the electronic component 30C. On the other hand, the bus bar 50B is disposed on the +Z direction side with respect to the electronic component 30C. The bus bar 50A is an example of the “first routing member”. The plate portion 50p of the bus bar 50A is an example of the "first plate portion". The bus bar 50B is an example of the “second routing member”. The plate portion 50p of the bus bar 50B is an example of the "second plate portion".

The connection component 40E is connected to the terminal 33A of the electronic component 30C. The connection component 40F is connected to the terminal 33B of the electronic component 30C. From the second viewpoint, the electronic component 30C is an example of the “first electronic component”. The terminal 33B of the electronic component 30C is an example of the “first terminal”. The terminal 33A of the electronic component 30C is an example of the “second terminal”.

The connection component 40F is disposed in the first posture. That is, the second portion 42 of the connection component 40F faces the -Z direction side. The connection component 40F is located between the connection portion 51B of the bus bar 50A and the terminal 33B of the electronic component 30C, and electrically connects the connection portion 51B of the bus bar 50A and the terminal 33B of the electronic component 30C. That is, the connection portion 51B of the bus bar 50A is electrically connected to the terminal 33B of the electronic component 30C by the connection component 40F. The connection component 40F is an example of the “first connection component”.

The connection component 40E is disposed in the second posture. That is, the second portion 42 of the connection component 40E faces the +Z direction side. The connection component 40E is located between the connection portion 51D of the bus bar 50B and the terminal 33A of the electronic component 30C, and electrically connects the connection portion 51D of the bus bar 50B and the terminal 33A of the electronic component 30C. That is, the connection portion 51D of the bus bar 50B is electrically connected to the terminal 33A of the electronic component 30C by the connection component 40E. The connection component 40E is an example of the “second connection component”.

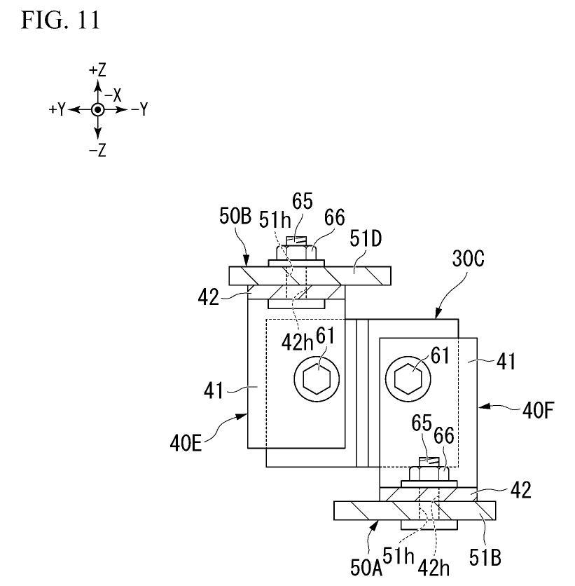

FIG. 11 is a front view showing a constitution related to one electronic component 30C. In the present embodiment, the connection component 40F is an L-shaped connection component. The connection component 40F includes a first portion 41 and a second portion 42. The first portion 41 of the connection component 40F extends in the Z direction. The second portion 42 of the connection component 40F extends in the X direction from an end portion on the -Z direction side of the first portion 41 of the connection component 40F, and is connected to the bus bar 50A from the +Z direction side.

In the present embodiment, the connection component 40E is an L-shaped connection component. The connection component 40E includes a first portion 41 and a second portion 42. The first portion 41 of the connection component 40E extends in the Z direction. The second portion 42 of the connection component 40E extends in the X direction from an end portion on the +Z direction side of the first portion 41 of the connection component 40E, and is connected to the bus bar 50B from the -Z direction side. That is, in the above constitution, the electronic component 30C is used as a relay member, and the lower routing layer RL1 and the upper routing layer RL2 are electrically connected by the two connection components 40E and 40F disposed in opposite directions about the electronic component 30C.

On the other hand, the connection component 40A is connected to the terminal 33A of the electronic component 30A. The connection component 40B is connected to the terminal 33B of the electronic component 30A. The connection component 40A and the connection component 40B are disposed in the first posture. That is, the second portion 42 of each of the connection component 40A and the connection component 40B faces the -Z direction side. The connection component 40B is located between the connection portion 51A of the bus bar 50A and the terminal 33B of the electronic component 30A, and electrically connects the connection portion 51A of the bus bar 50A and the terminal 33B of the electronic component 30A. That is, the connection portion 51A of the bus bar 50A is electrically connected to the terminal 33B of the electronic component 30A by the connection component 40B. Similarly, the connection component 40A is located between the bus bar 50D and the terminal 33A of the electronic component 30A, and electrically connects the bus bar 50D and the terminal 33A of the electronic component 30A. That is, the bus bar 50D is electrically connected to the terminal 33A of the electronic component 30A by the connection component 40A.

In addition, the connection component 40C is connected to the terminal 33A of the electronic component 30B. The connection component 40D is connected to the terminal 33B of the electronic component 30B. The connection component 40C and the connection component 40D are disposed in the second posture. That is, the second portion 42 of each of the connection component 40C and the connection component 40D faces the +Z direction side. The connection component 40C is located between the connection portion 51C of the bus bar 50B and the terminal 33A of the electronic component 30B, and electrically connects the connection portion 51C of the bus bar 50B and the terminal 33A of the electronic component 30B. That is, the connection portion 51C of the bus bar 50B is electrically connected to the terminal 33A of the electronic component 30B by the connection component 40C. Similarly, the connection component 40D is located between another connection component 40H and the terminal 33B of the electronic component 30B, and electrically connects the connection component 40H and the terminal 33B of the electronic component 30B. That is, the connection component 40H is electrically connected to the terminal 33B of the electronic component 30B by the connection component 40D.

### 4.2 Structure Using Second-Type Connection Component

Returning to FIG. 8, the constitution related to one electronic component 30H will be described. The connection component 40P is connected to the terminal 33A of the electronic component 30H. The connection component 40Q is connected to the terminal 33B of the electronic component 30H.

The connection component 40Q is disposed in the first posture. That is, the second portion 42 of the connection component 40Q is disposed on the -Z direction side with respect to the first portion 41 of the connection component 40Q. The second portion 42 of the connection component 40Q extends in the X direction from an end portion on the -Z direction side of the first portion 41 of the connection component 40Q. The second portion 42 of the connection component 40Q faces the -Z direction side. The connection component 40Q is located between the connection portion 51 of the bus bar 50I and the terminal 33B of the electronic component 30H, and electrically connects the connection portion 51 of the bus bar 50I and the terminal 33B of the electronic component 30H. That is, the connection portion 51 of the bus bar 50I is electrically connected to the terminal 33B of the electronic component 30H by the connection component 40Q.

On the other hand, the connection component 40P is disposed in the second posture. That is, the second portion 42 of the connection component 40P is disposed on the +Z direction side with respect to the first portion 41 of the connection component 40P. The second portion 42 of the connection component 40P extends in the X direction from an end portion on the +Z direction side of the first portion 41 of the connection component 40P. The second portion 42 of the connection component 40P faces the +Z direction side. The connection component 40P is located between the connection portion 51 of the bus bar 50G and the terminal 33A of the electronic component 30H, and electrically connects the connection portion 51 of the bus bar 50G and the terminal 33A of the electronic component 30H. That is, the connection portion 51 of the bus bar 50G is electrically connected to the terminal 33A of the electronic component 30H by the connection component 40P.

Here, between a plate thickness T3 of the plate portion 50p of the bus bar 50I and a plate thickness T4 of the plate portion 50p of the bus bar 50G, the smaller plate thickness is equal to or larger than half of the larger plate thickness. For example, the plate thickness T3 of the plate portion 50p of the bus bar 50I and the plate thickness T4 of the plate portion 50p of the bus bar 50G are the same.

That is, in the above constitution, the electronic component 30H is used as a relay member, and the lower routing layer RL1 and the upper routing layer RL2 are electrically connected by the two connection components 40Q and 40P disposed in opposite directions about the electronic component 30H.

### 5. Constitution Common to First and Second Viewpoints

### 5.1 Fixing Structure between Connection Component and Bus Bar

Next, a fixing structure between the connection component 40 and the bus bar 50 will be described.

As illustrated in FIG. 6, the fastening member 65 for fastening the bus bar 50A and the connection component 40 (for example, the connection component 40B or the connection component 40F) is attached to each of the plurality of connection portions 51 of the bus bar 50A. For example, the fastening member 65 is inserted into the attachment hole 51h of the bus bar 50A and the attachment hole 42h of the connection component 40 from the -Z direction side, and penetrates the bus bar 50A and the connection component 40 in the Z direction. The engagement member 66 is attached to and engaged with, from the +Z direction side, the tip portion of the fastening member 65 passed through the attachment hole 51h of the bus bar 50A and the attachment hole 42h of the connection component 40. With this constitution, the bus bar 50A and the connection component 40 are fastened. The fastening member 65 attached to the connection portion 51 of the bus bar 50A is an example of a "first fastening member". The engagement member 66 that engages with the fastening member 65 is an example of a "first engagement member".

On the other hand, the fastening member 65 for fastening the bus bar 50B and the connection component 40 (for example, the connection component 40C or the connection component 40E) is attached to each of the plurality of connection portions 51 of the bus bar 50B. For example, the fastening member 65 is inserted into the attachment hole 42h of the connection component 40 and the attachment hole 51h of the bus bar 50B from the -Z direction side, and penetrates the connection component 40 and the bus bar 50B in the Z direction. The engagement member 66 is attached to and engaged with, from the +Z direction side, the tip portion of the fastening member 65 passed through the attachment hole 42h of the connection component 40 and the attachment hole 51h of the bus bar 50A. With this constitution, the bus bar 50B and the connection component 40 are fastened. The fastening member 65 attached to the connection portion 51 of the bus bar 50B is an example of a "second fastening member". The engagement member 66 that engages with the fastening member 65 is an example of a "second engagement member".

### 5.2 Support Structure between Electronic Component and Bus Bar

Next, a support structure between the electronic component 30 and the bus bar 50 will be described.

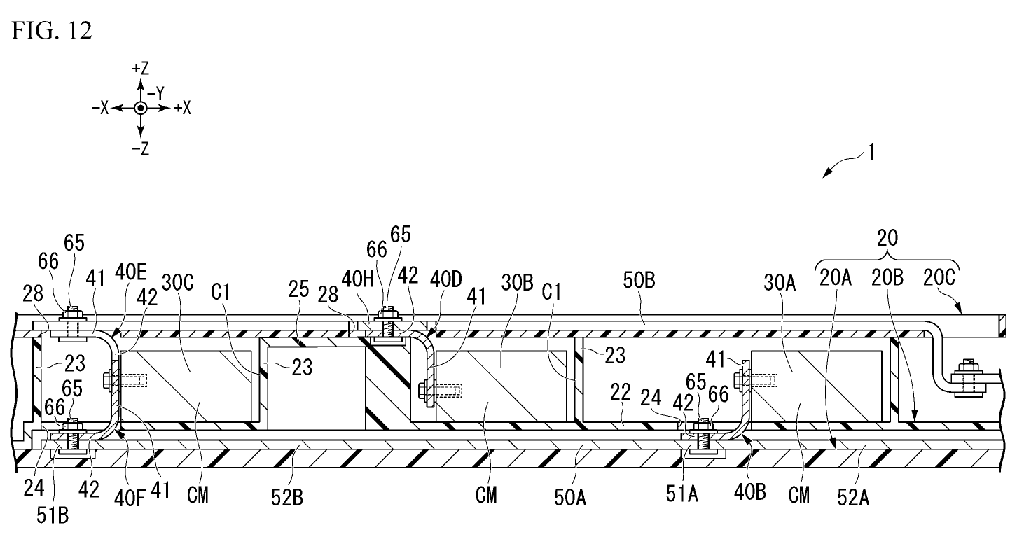

FIG. 12 is a cross-sectional view showing the base member 20. In the present embodiment, the base member 20 includes, for example, a first base member 20A, a second base member 20B, and a third base member 20C. Each of the first base member 20A, the second base member 20B, and the third base member 20C is made of, for example, synthetic resin and has an insulating property.

### First Base Member

First, the first base member 20A will be described.

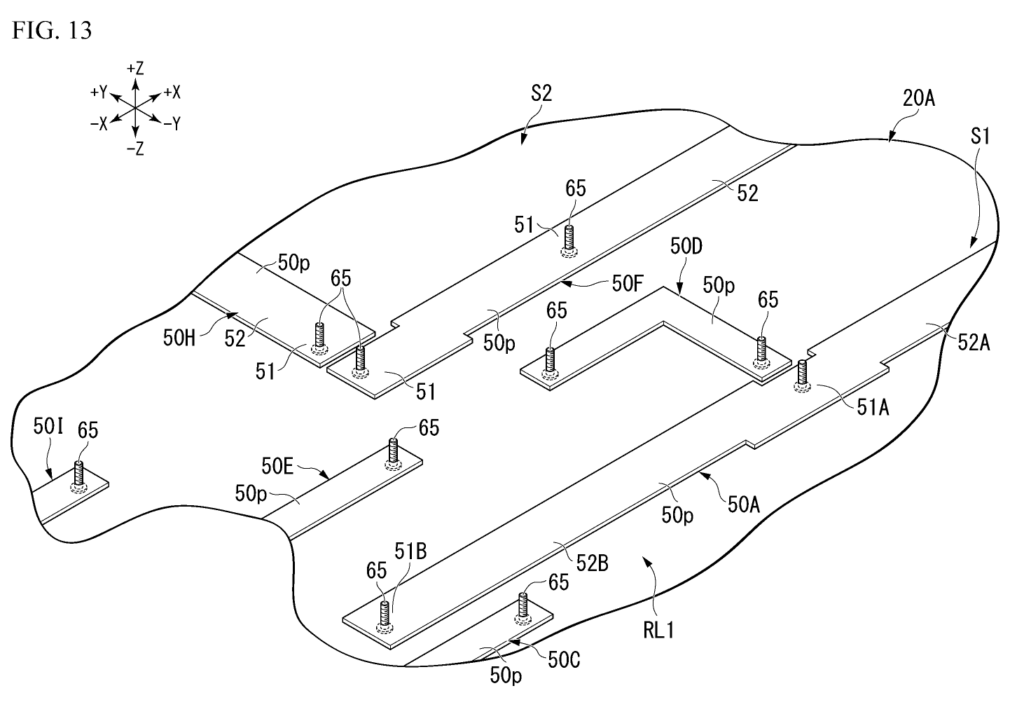

FIG. 13 is a perspective view showing the first base member 20A. The first base member 20A is located at the lowermost position among the three base members 20A, 20B, and 20C. The first base member 20A has a plate shape along the X direction and the Y direction, for example. The plurality of bus bars 50 included in the lower routing layer RL1 is placed on the first base member 20A and supported from below by the first base member 20A. For example, the first base member 20A integrally supports the bus bars 50A, 50C, 50D, and 50E included in the first structure S1 and the bus bars 50F and 50H included in the second structure S2. Note that, instead of the above example, the first base member 20A may have an accommodation portion that is a recess or a through-hole in which at least a part of each bus bar 50 is accommodated.

### Second Base Member

Next, the second base member 20B will be described.

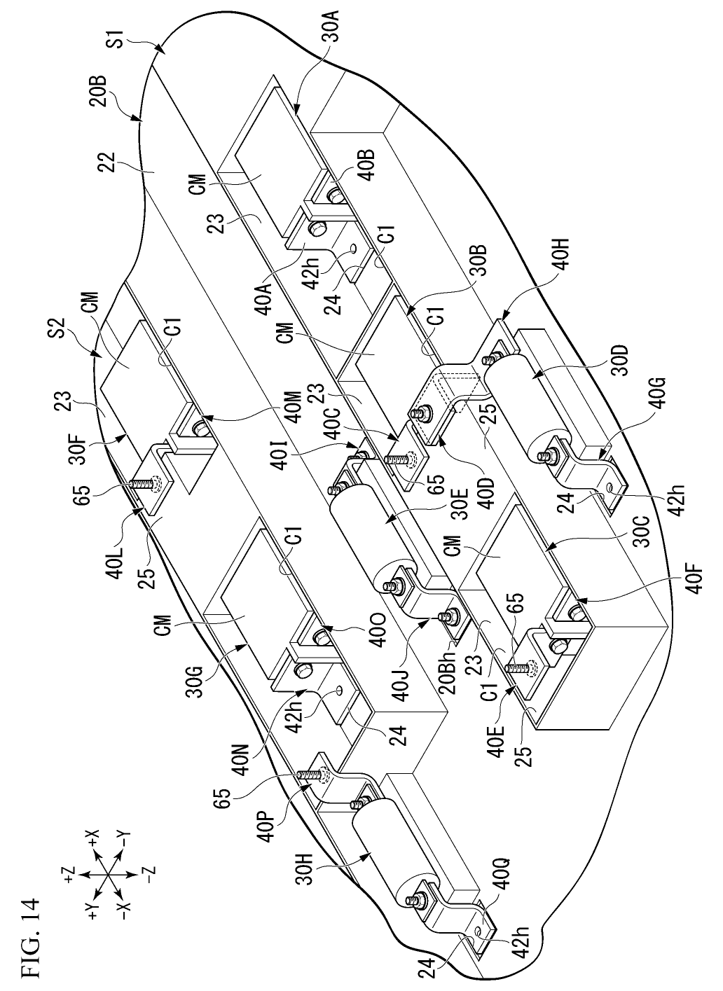

FIG. 14 is a perspective view showing the second base member 20B. The second base member 20B is located at the middle in the Z direction among the three base members 20A, 20B, and 20C. The second base member 20B has the fixing portion 21 (see FIG. 2) described above, and the plurality of electronic components 30 is attached to the second base member 20B.

The second base member 20B has, for example, a base portion 22, an insulating wall 23, an opening 24, and a support portion 25. The base portion 22 is a plate portion provided along the X direction and the Y direction. The fixing portion 21 is provided, for example, on the base portion 22. The insulating wall 23 stands in the +Z direction from the base portion 22. The insulating wall 23 surrounds the individual electronic components 30. An accommodation portion C1 in which the electronic component 30 is accommodated is formed inside the insulating wall 23. The insulating wall 23 is located between the two adjacent electronic components 30, and electrically insulates the two adjacent electronic components 30 from each other. The opening 24 is provided at a position corresponding to the connection component 40 disposed in the first posture in the base portion 22. The opening 24 exposes the connection component 40 disposed in the first posture in the +Z direction.

The support portion 25 is disposed corresponding to the connection component 40 disposed in the second posture. The support portion 25 faces the second portion 42 of the connection component 40 disposed in the second posture when viewed from the Z direction. For example, the support portion 25 is in contact with the second portion 42 of the connection component 40 from below. The support portion 25 supports the second portion 42 of the connection component 40 from below when a force in the -Z direction acts on the connection component 40, for example.

### Third Base Member

Next, the third base member 20C will be described. The third base member 20C is disposed between the electronic components 30A, 30B, 30C, 30D, and 30E and the bus bar 50B, and between the electronic components 30F, 30G, and 30H and the bus bar 50G. The third base member 20C covers the plate portion 50p of each of the bus bars 50B and 50G from the -Z direction side, and supports the plate portion 50p of each of the bus bars 50B and 50G from below.

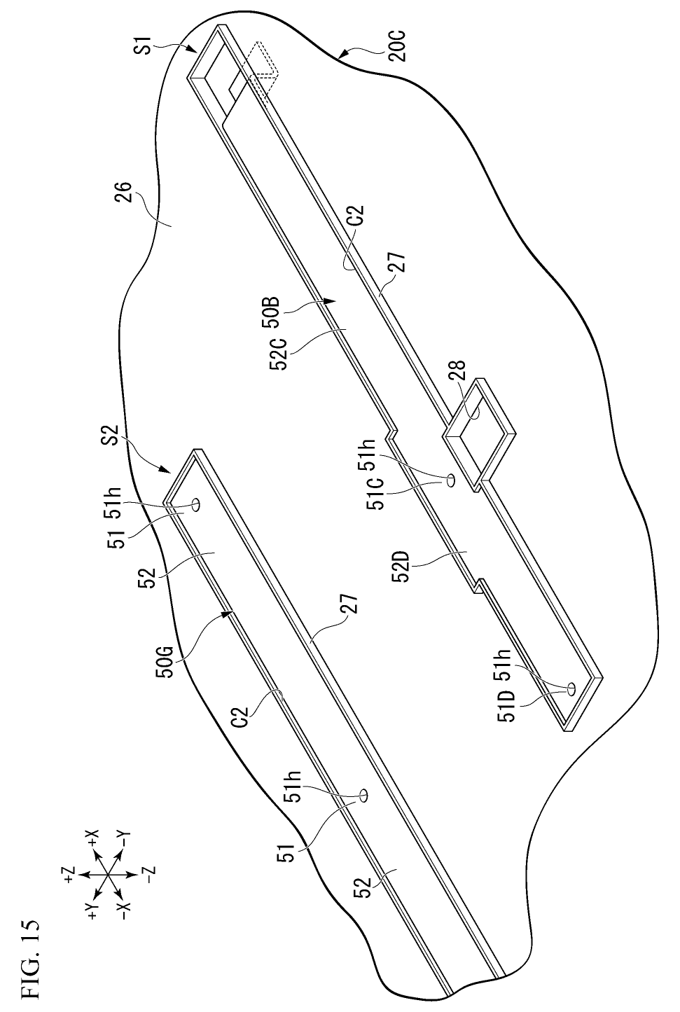

FIG. 15 is a perspective view showing the third base member 20C. The third base member 20C is located at the uppermost position among the three base members 20A, 20B, and 20C. The third base member 20C has a plate shape along the X direction and the Y direction, for example. The plurality of bus bars 50 included in the upper routing layer RL2 is placed on the third base member 20C and supported from below by the third base member 20C.

The third base member 20C has, for example, a base portion 26, an insulating wall 27, and an opening 28. The base portion 26 is a plate portion provided along the X direction and the Y direction. The base portion 26 is positioned below the plurality of bus bars 50 (for example, the bus bar 50B and the bus bar 50G) included in the upper routing layer RL2, and supports the plurality of bus bars 50 from below. For example, the base portion 26 integrally supports the bus bar 50B included in the first structure S1 and the bus bar 50G included in the second structure S2.

The insulating wall 27 stands in the +Z direction from the base portion 26. The insulating wall 27 surrounds the individual bus bars 50 (for example, the bus bar 50B or the bus bar 50C). An accommodation portion C2 in which the bus bar 50 is accommodated is formed inside the insulating wall 27. The insulating wall 27 is located between two adjacent bus bars 50 (for example, the bus bar 50B and the bus bar 50C), and electrically insulates the two adjacent bus bars 50 from each other.

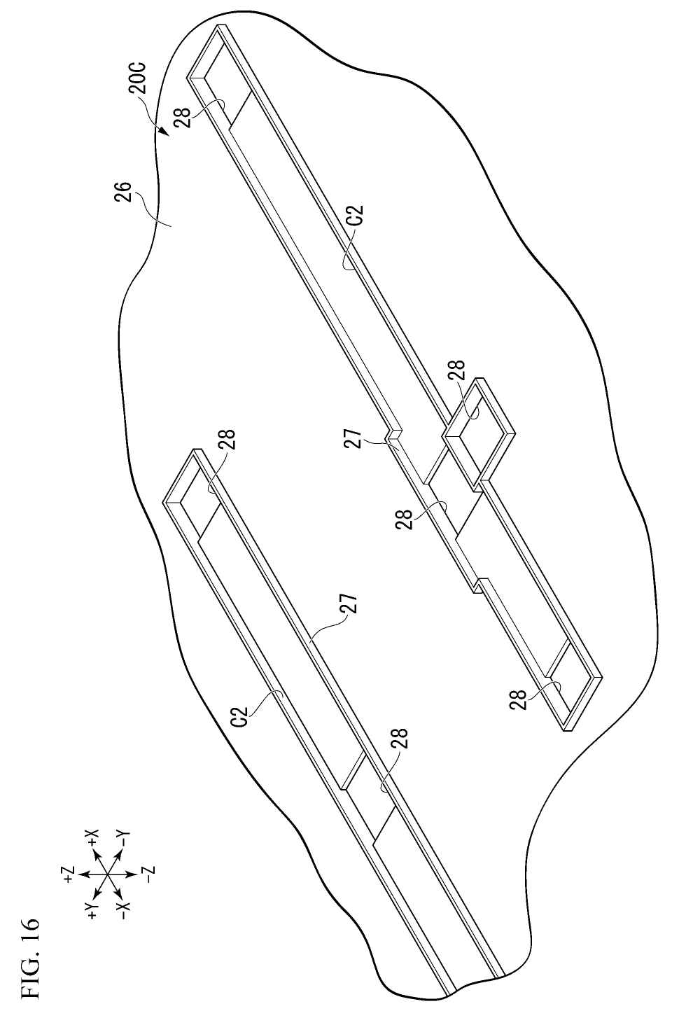

FIG. 16 is another perspective view showing the third base member 20C. The openings 28 are provided at positions corresponding to the connection components 40 disposed in the second posture in the base portion 26. The openings 28 expose the connection portions 51 of the plurality of bus bars 50 included in the upper routing layer RL2 in the -Z direction.

### 6. Advantages

### 6.1 Advantages of First Viewpoint

As a comparative example, a constitution in which the upper routing layer RL2 is not provided and all the routing members are provided in the lower routing layer RL1 will be considered. Here, in recent years, the number of electronic components mounted on the electrical connection unit has increased with the increase in functionality of the electrical connection unit, and the routing path has become complicated. In the constitution of the above-described comparative example, a plurality of routing members is often disposed on the same plane, and it is necessary to form a bypass for avoiding interference with another routing member in one or more routing members. For this reason, in the constitution of the comparative example, it is difficult to advance downsizing. For this reason, the electrical connection unit tends to be large (for example, the set area tends to be large).

On the other hand, in the present embodiment, the electrical connection unit includes the first electronic component (for example, the electronic component 30A), the first connection component (for example, the connection component 40B), the first routing member (for example, the bus bar 50A), and the second routing member (for example, the bus bar 50B). The first electronic component includes the component body (for example, the component body CM), the first terminal (for example, the terminal 33B), and the second terminal (for example, the terminal 33A). The first connection component is connected to the first terminal of the first electronic component. When a direction in which the first terminal and the second terminal are adjacent to each other is defined as the first direction (for example, the Y direction), a direction intersecting the first direction and in which the component body and the first connection component are adjacent to each other is defined as the second direction (for example, the X direction), and a direction intersecting the first direction and the second direction is defined as the third direction (for example, the Z direction), the first routing member includes the first plate portion (for example, the plate portion 50p) along the first direction and the second direction. The first plate portion is disposed on the first side (for example, the -Z direction side) in the third direction with respect to the first electronic component, and overlaps at least one of the first electronic component or the first connection component when viewed from the third direction. The second routing member includes the second plate portion (for example, the plate portion 50p) along the first direction and the second direction. The second plate portion is disposed on the second side (for example, the +Z direction side) opposite to the first side in the third direction with respect to the first electronic component, and overlaps at least one of the first electronic component or the first connection component when viewed from the third direction. Between the plate thickness of the second plate portion and the plate thickness of the first plate portion, the smaller plate thickness is equal to or larger than half of the larger plate thickness.

With such a constitution, the first routing member and the second routing member are separately disposed on both sides of the first electronic component in the third direction. With this constitution, the first routing member and the second routing member are easily disposed while avoiding interference with each other. Therefore, it becomes unnecessary or there is a small necessity to form a bypass in the first routing member or the second routing member. With this constitution, the electrical connection unit can be downsized.

In the present embodiment, the first plate portion overlaps the first electronic component when viewed from the third direction. The second plate portion overlaps the first electronic component when viewed from the third direction. With such a constitution, by disposing the first routing member and the second routing member separately on both sides of the first electronic component in the third direction, both the first routing member and the second routing member can be disposed at positions overlapping the first electronic component when viewed from the third direction. Thus, the electrical connection unit can be further downsized.

In the present embodiment, the electrical connection unit further includes the second electronic component (for example, the electronic component 30B). The second plate portion extends in the second direction, is disposed on the second side in the third direction with respect to the first electronic component and the second electronic component, and overlaps the first electronic component and the second electronic component when viewed from the third direction. With such a constitution, the second routing member can be disposed at a position overlapping both the first electronic component and the second electronic component when viewed from the third direction. Thus, the electrical connection unit can be further downsized.

In the present embodiment, the electrical connection unit includes the second electronic component (for example, the electronic component 30B) and the second connection component (for example, the connection component 40C). The second electronic component is adjacent to the first electronic component in the second direction. The second electronic component includes the third terminal (for example, the terminal 33A) and the fourth terminal (for example, the terminal 33B). The second connection component is connected to the third terminal of the second electronic component. The first routing member is electrically connected to the first electronic component by the first connection component. The second routing member is electrically connected to the second electronic component by the second connection component. The second plate portion extends in the second direction and overlaps at least one of the second electronic component or the second connection component when viewed from the third direction.

With such a constitution, the second routing member is disposed on the second side in the third direction with respect to the first electronic component and the second electronic component across the first electronic component and the second electronic component, and widely extends across the first electronic component and the second electronic component. With this constitution, the first routing member and the second routing member are easily disposed while further avoiding interference with each other. With this constitution, the electrical connection unit can be further downsized.

In the present embodiment, the second plate portion includes the first end portion (for example, the end portion 50Be1), the second end portion (for example, the end portion 50Be2) located on a side opposite to the first end portion in the second direction, and the connection portion (for example, the connection portion 51A) located between the first end portion and the second end portion. The connection portion overlaps the second connection component when viewed from the third direction, and is connected to the second connection component.

With such a constitution, the second plate portion is connected to the second connection component not at the first end portion or the second end portion but at a position between the first end portion and the second end portion. With this constitution, the second plate portion can be largely extended in any direction. With this constitution, the first routing member and the second routing member are easily disposed while further avoiding interference with each other. With this constitution, the electrical connection unit can be further downsized.

In the present embodiment, the electrical connection unit includes the first fastening member (for example, the fastening member 65) and the second fastening member (for example, another fastening member 65). The first fastening member penetrates the first routing member and the first connection component in the third direction. In the first fastening member, the first engagement member (for example, the engagement member 66) is attached from the second side in the third direction to fasten the first routing member and the first connection component. The second fastening member penetrates the second routing member and the second connection component in the third direction. In the second fastening member, the second engagement member (for example, another engagement member 66) is attached from the second side in the third direction to fasten the second routing member and the second connection component.

With such a constitution, the direction of the fastening work of the first routing member and the first connection component using the first fastening member can be aligned with the direction of the fastening work of the second routing member and the second connection component using the second fastening member. With this constitution, assembling workability of the electrical connection unit can be enhanced.

In the present embodiment, the electrical connection unit further includes the third electronic component (for example, the electronic component 30C). The third electronic component is located on a side opposite to the first electronic component with respect to the second electronic component, and at least partially overlaps the first electronic component and the second electronic component when viewed from the second direction. The second plate portion extends in the second direction to the vicinity of the third electronic component with respect to the second electronic component when viewed from the first electronic component, and is electrically connected to the third electronic component. With such a constitution, the second routing member extending to the vicinity of the third electronic component and the first routing member hardly interfere with each other. With this constitution, the electrical connection unit can be further downsized.

In the present embodiment, the electrical connection unit further includes the second electronic component (for example, the electronic component 30B) and the third electronic component (for example, the electronic component 30C). The second electronic component includes the third terminal (for example, the terminal 33A) and the fourth terminal (for example, the terminal 33B). The third electronic component includes the fifth terminal (for example, the terminal 33B) and the sixth terminal (for example, the terminal 33A). The first plate portion is electrically connected to the first terminal of the first electronic component and the fifth terminal of the third electronic component. The second plate portion is electrically connected to the third terminal of the second electronic component and the sixth terminal of the third electronic component. With such a constitution, the first routing member connecting the first electronic component and the third electronic component and the second routing member connecting the second electronic component and the third electronic component hardly interfere with each other. With this constitution, the electrical connection unit can be further downsized.

In the present embodiment, the electrical connection unit further includes the third electronic component (for example, the electronic component 30C) and the third connection component (for example, the connection component 40E). The third electronic component is disposed on a side opposite to the first electronic component with respect to the second electronic component, and the third electronic component includes the fifth terminal (for example, the terminal 33A) and the sixth terminal (for example, the terminal 33B). The third connection component is connected to the fifth terminal of the third electronic component. The second plate portion overlaps at least one of the third electronic component or the third connection component when viewed from the third direction.

With such a constitution, the second routing member is disposed on the second side in the third direction with respect to the first electronic component, the second electronic component, and the third electronic component across the first electronic component and the third electronic component. With this constitution, the first routing member and the second routing member are easily disposed while further avoiding interference with each other. With this constitution, the electrical connection unit can be further downsized.

In the present embodiment, the electrical connection unit further includes an insulating base member (for example, the base member 20C). The base member is disposed between the first electronic component and the second routing member and between the second electronic component and the second routing member. The base member covers the second routing member from the first side and includes the accommodation portion (for example, the accommodation portion C2) that accommodates the second routing member.

With such a constitution, assemblability related to the second routing member can be enhanced. With this constitution, assembling workability of the electrical connection unit can be enhanced.

In the present embodiment, the electrical connection unit includes the first electronic component (for example, the electronic component 30A), the second electronic component (for example, the electronic component 30B), the first routing member (for example, the bus bar 50A), and the second routing member (for example, the bus bar 50B). The first electronic component includes the first terminal (for example, the terminal 33A) and the second terminal (for example, the terminal 33B) adjacent to each other in the first direction. The second electronic component is adjacent to the first electronic component in the second direction intersecting the first direction. The first routing member includes the first plate portion (for example, the plate portion 50p) along the first direction and the second direction. The first plate portion is, when a direction intersecting the first direction and the second direction is defined as a third direction, disposed on the first side (for example, the -Z direction side) in the third direction with respect to the first electronic component, and overlaps the first electronic component when viewed from the third direction. The second routing member includes the second plate portion (for example, the plate portion 50p) along the first direction and the second direction. The second plate portion is disposed on the second side (for example, the +Z direction side) opposite to the first side in the third direction with respect to the first electronic component, and overlaps the first electronic component and the second electronic component when viewed from the third direction. Between the plate thickness of the second plate portion and the plate thickness of the first plate portion, the smaller plate thickness is equal to or larger than half of the larger plate thickness.

With such a constitution, the first routing member and the second routing member are separately disposed on both sides of the first electronic component in the third direction. With this constitution, the first routing member and the second routing member are easily disposed while avoiding interference with each other. Therefore, it becomes unnecessary or there is a small necessity to form a bypass in the first routing member or the second routing member. With this constitution, the electrical connection unit can be downsized.

### 6.2 Advantages of Second Viewpoint

As a comparative example, a constitution in which all the connection components 40 are disposed in the first posture will be considered. In such a constitution, a dedicated vertical routing member is necessary for connecting the routing member disposed in the lower routing layer RL1 and the routing member disposed in the upper routing layer RL2. Therefore, with the above constitution, it is difficult to advance downsizing. For this reason, the electrical connection unit tends to be large (for example, the set area tends to be large).

On the other hand, in the present embodiment, the electrical connection unit includes the first electronic component (for example, the electronic component 30C), the first connection component (for example, the connection component 40F), the second connection component (for example, the connection component 40E), the first routing member (for example, the bus bar 50A), and the second routing member (for example, the bus bar 50B). The first electronic component includes the component body (for example, the component body CM), the first terminal (for example, the terminal 33B), and the second terminal (for example, the terminal 33A). The first connection component is connected to the first terminal of the first electronic component. The second connection component is connected to the second terminal of the first electronic component. The first routing member includes the first plate portion (for example, the plate portion 50p). When a direction in which the first terminal and the second terminal are adjacent to each other is defined as the first direction (for example, the Y direction), a direction intersecting the first direction and in which the component body and the first connection component are adjacent to each other is defined as the second direction (for example, the X direction), and a direction intersecting the first direction and the second direction is defined as the third direction (the Z direction), the first plate portion is disposed on the first side (-Z direction side) in the third direction with respect to the first electronic component. The first routing member is connected to the first electronic component by the first connection component. The second routing member includes the second plate portion (for example, the plate portion 50p). The second plate portion is disposed on the second side (for example, the +Z direction side) opposite to the first side in the third direction with respect to the first electronic component. Between the plate thickness of the second plate portion and the plate thickness of the first plate portion, the smaller plate thickness is equal to or larger than half of the larger plate thickness. The second routing member is connected to the first electronic component by the second connection component.

With such a constitution, the first electronic component is used as the relay member, and the first routing member and the second routing member can be electrically connected by the first connection component and the second connection component disposed about the first electronic component. With this constitution, it is possible to reduce the necessity of a dedicated routing member that directly connects the first routing member and the second routing member. With this constitution, the electrical connection unit can be downsized.

In the present embodiment, the first plate portion overlaps the first electronic component when viewed from the third direction. The second plate portion overlaps the first electronic component when viewed from the third direction. With such a constitution, by disposing the first routing member and the second routing member separately on both sides of the first electronic component in the third direction, the first connection component and the second connection component can be downsized Thus, the electrical connection unit can be further downsized.

In the present embodiment, the first terminal is a positive electrode terminal of the first electronic component. The second terminal is a negative electrode terminal of the first electronic component. With such a constitution, the first routing member and the second routing member can be connected by the first connection component for the positive electrode and the second connection component for the negative electrode. With this constitution, the electrical connection unit can be downsized.

In the present embodiment, the first connection component includes the first portion (for example, the first portion 41) extending in the third direction, and the second portion (for example, the second portion 42) extending in the second direction from the end portion of the first portion on the first side in the third direction and connected to the first routing member. The second connection component includes the third portion (for example, the first portion 41) extending in the third direction, and the second portion (for example, the second portion 42) extending in the second direction from the end portion of the third portion on the second side in the third direction and connected to the second routing member. With such a constitution, the stability of the connection between the first connection component and the first routing member is improved, and the stability of the connection between the second connection component and the second routing member is improved. With this reason, the reliability of the electrical connection unit can be further improved.

In the present embodiment, the electrical connection unit includes the first electronic component (for example, the electronic component 30C or the electronic component 30H), the first connection component (for example, the connection component 40F or the connection component 40Q), the second connection component (for example, the connection component 40E or the connection component 40P), the first routing member (for example, the bus bar 50A or the bus bar 50I), and the second routing member (for example, the bus bar 50B or the bus bar 50G). The first electronic component includes the component body (for example, the component body CM), the first terminal (for example, the terminal 33B), and the second terminal (for example, the terminal 33A). The first connection component is connected to the first terminal of the first electronic component. The second connection component is connected to the second terminal of the first electronic component. The first routing member includes the first plate portion (for example, the plate portion 50p). When a direction in which the first terminal and the second terminal are adjacent to each other is defined as the first direction (for example, the Y direction or the X direction) and a direction intersecting the first direction is defined as the third direction (the Z direction), the first plate portion is disposed on the first side (-Z direction side) in the third direction with respect to the first electronic component. The first routing member is connected to the first electronic component by the first connection component. The second routing member includes the second plate portion (for example, the plate portion 50p). The second plate portion is disposed on the second side (for example, the +Z direction side) opposite to the first side in the third direction with respect to the first electronic component. Between the plate thickness of the second plate portion and the plate thickness of the first plate portion, the smaller plate thickness is equal to or larger than half of the larger plate thickness. The second routing member is connected to the first electronic component by the second connection component.

With such a constitution, the first electronic component is used as the relay member, and the first routing member and the second routing member can be electrically connected by the first connection component and the second connection component disposed about the first electronic component. With this constitution, it is possible to reduce the necessity of a dedicated routing member that directly connects the first routing member and the second routing member. With this constitution, the electrical connection unit can be downsized.

### 7. Modifications

Next, several modifications will be described. Note that a constitution other than that described below in each modification is the same as the constitution of the above-described embodiment.

### 7.1 First Modification

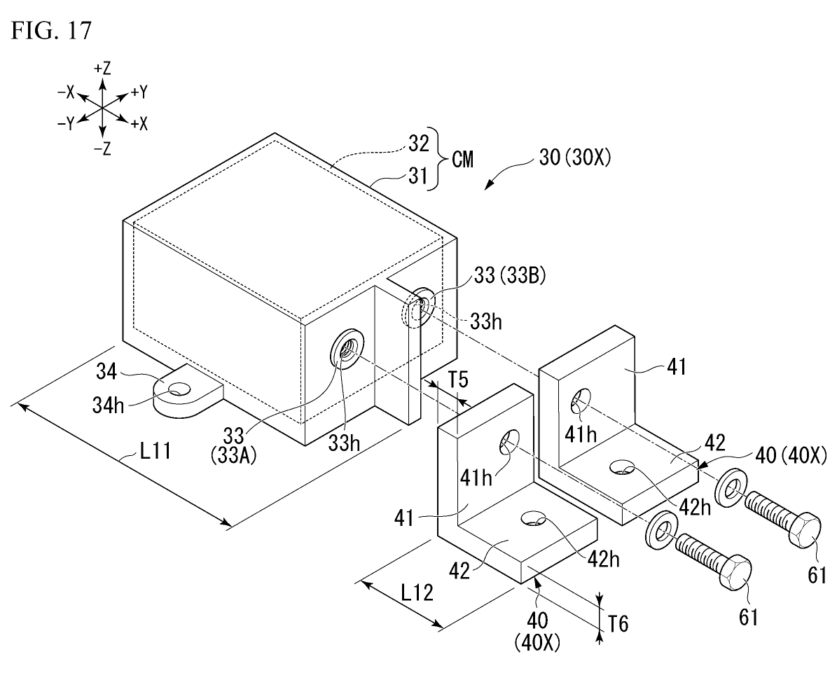

FIG. 17 is a perspective view showing the connection component 40X of the first modification. In the present modification, the connection component 40X is an L-shaped metal block. For example, a thickness T5 of the first portion 41 of the connection component 40X in the X direction is larger than the plate thickness T1 of the bus bar 50A and larger than the plate thickness T2 of the bus bar 50B. In addition, a thickness T6 of the second portion 42 of the connection component 40X in the Z direction is larger than the plate thickness T1 of the bus bar 50A and larger than the plate thickness T2 of the bus bar 50B. In addition, the thickness T5 of the first portion 41 of the connection component 40X in the X direction is larger than the plate thickness T3 of the bus bar 50F and larger than the plate thickness T4 of the bus bar 50G. The connection component 40X of the first modification is a heat storage component having a larger heat capacity than the plate material.

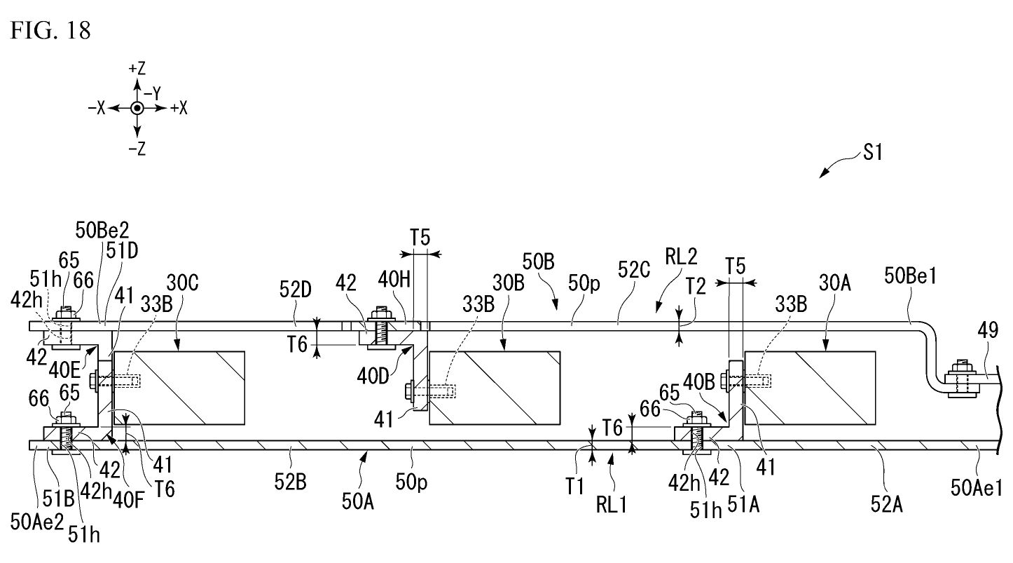

FIG. 18 is a cross-sectional view illustrating the electrical connection unit 1 of the first modification. In the first modification, the connection components 40A to 40F and the connection components 40L to 40O are formed by the above-described connection component 40X. Then, the connection components 40A, 40B, 40F, 40M, 40N, and 40O are disposed in the first posture, and are physically and electrically connected to the bus bar 50 (for example, the bus bar 50A or the bus bar 50F) included in the lower routing layer RL1. On the other hand, the connection components 40C, 40D, 40E, and 40L are disposed in the second posture, and are physically and electrically connected to the bus bar 50 (for example, the bus bar 50B or the bus bar 50G) included in the upper routing layer RL2.

With such a constitution, the heat storage property of the electrical connection unit can be improved. With this constitution, for example, a temperature rise can be suppressed when a large current flows for a short time. Thus, the thermal characteristics of the electrical connection unit can be improved. According to another viewpoint, with the above constitution, the electronic component is used as the relay member, and the routing member included in the lower routing layer and the routing member included in the upper routing layer can be electrically connected to each other by the two heat storage components disposed in the postures opposite to each other about the electronic component.

### 7.2 Second Modification

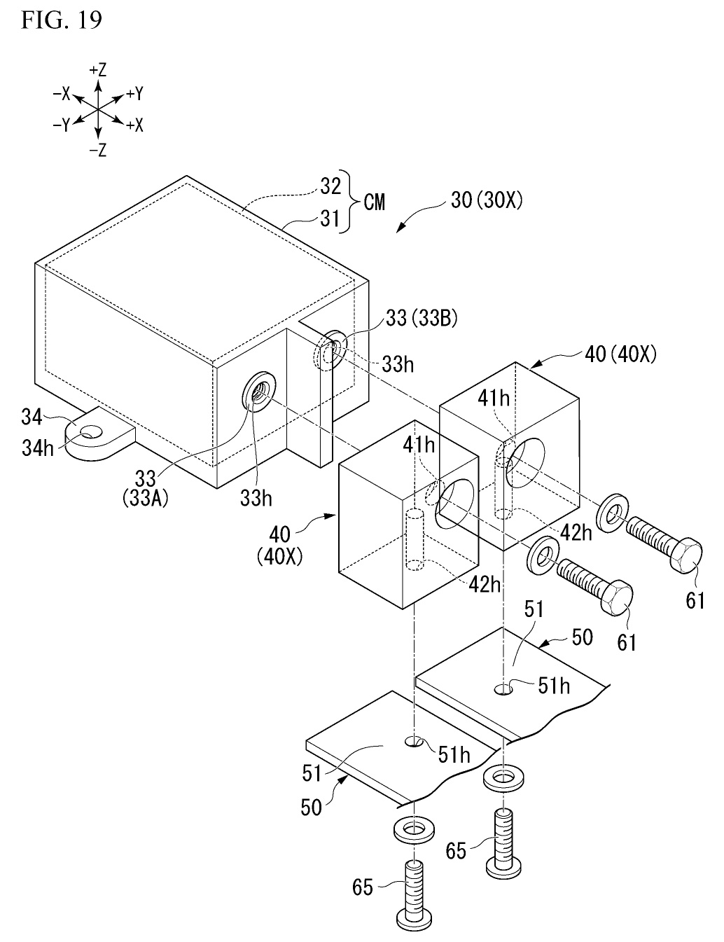

FIG. 19 is a perspective view showing the connection component 40X of the second modification. In the present modification, the connection component 40X is a rectangular parallelepiped metal block. For example, the connection component 40X extends in the Z direction. The connection component 40X has the attachment hole 41h and the attachment hole 42h. In the present modification, the attachment hole 42h is a bottomed engagement hole. An inner surface of the attachment hole 42h has a screw groove. The connection component 40X of the second modification is a heat storage component having a larger heat capacity than the plate material.

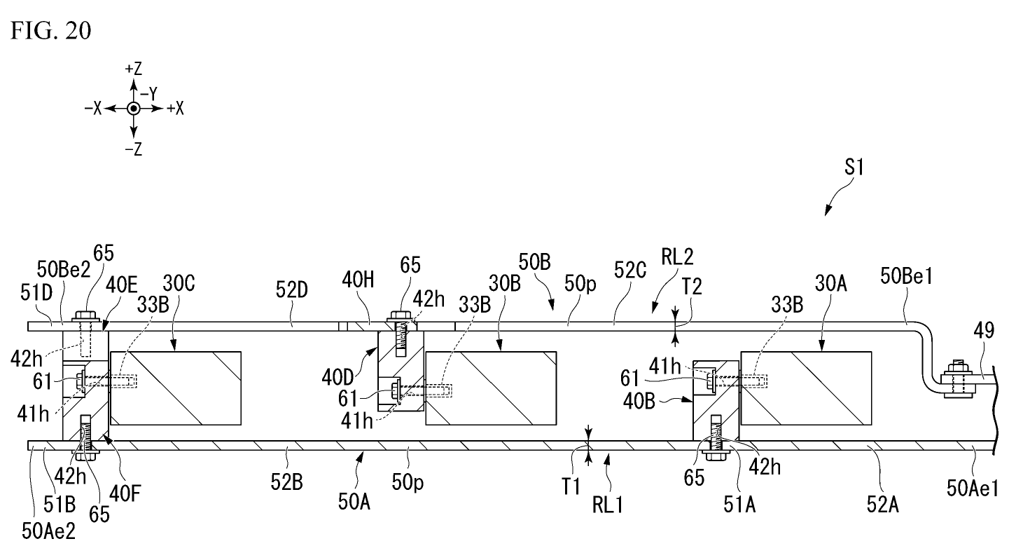

FIG. 20 is a cross-sectional view illustrating the electrical connection unit 1 of the second modification. In the second modification, the connection components 40A to 40F and the connection components 40L to 40O are formed by the above-described connection component 40X. Then, the connection components 40A, 40B, 40F, 40M, 40N, and 40O are disposed in the first posture with the attachment holes 42h facing downward, and are physically and electrically connected to the bus bar 50 (for example, the bus bar 50A or the bus bar 50F) included in the lower routing layer RL1. On the other hand, the connection components 40C, 40D, 40E, and 40L are disposed in the second posture with the attachment holes 42h facing upward, and are physically and electrically connected to the bus bar 50 (for example, the bus bar 50B or the bus bar 50G) included in the upper routing layer RL2.

With such a constitution, the heat storage property of the electrical connection unit can be improved. With this constitution, for example, a temperature rise can be suppressed when a large current flows for a short time. Thus, the thermal characteristics of the electrical connection unit can be improved. According to another viewpoint, with the above constitution, the electronic component is used as the relay member, and the routing member included in the lower routing layer and the routing member included in the upper routing layer can be electrically connected to each other by the two heat storage components disposed in the postures opposite to each other about the electronic component.

### 7.3 Third Modification

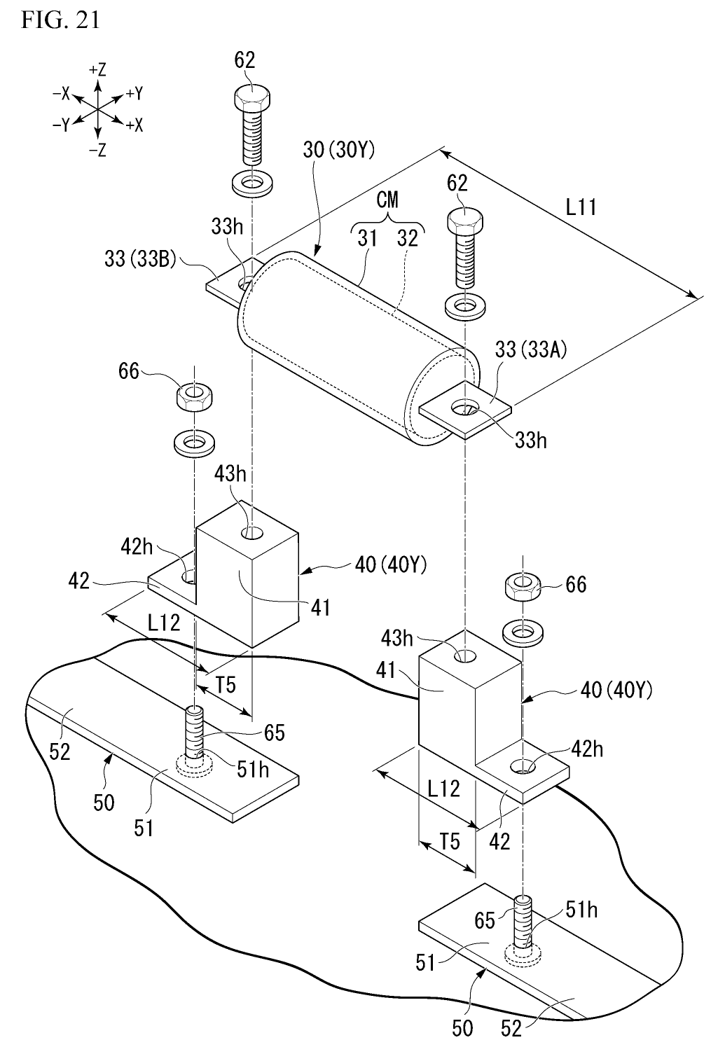

FIG. 21 is a perspective view showing the connection component 40Y of the third modification. In the present modification, the connection component 40Y is an L-shaped metal block. The connection component 40Y does not include the third portion 43, but includes the first portion 41 and the second portion 42. The first portion 41 has the attachment hole 43h. In the present modification, the attachment hole 43h is a bottomed engagement hole. An inner surface of the attachment hole 43h has a screw groove. In the present modification, a thickness T5 of the first portion 41 of the connection component 40Y in the X direction is larger than the plate thickness T1 of the bus bar 50A and larger than the plate thickness T2 of the bus bar 50B. In addition, the thickness T5 of the first portion 41 of the connection component 40Y in the X direction is larger than the plate thickness T3 of the bus bar 50F and larger than the plate thickness T4 of the bus bar 50G. The connection component 40Y of the third modification is a heat storage component having a larger heat capacity than the plate material.

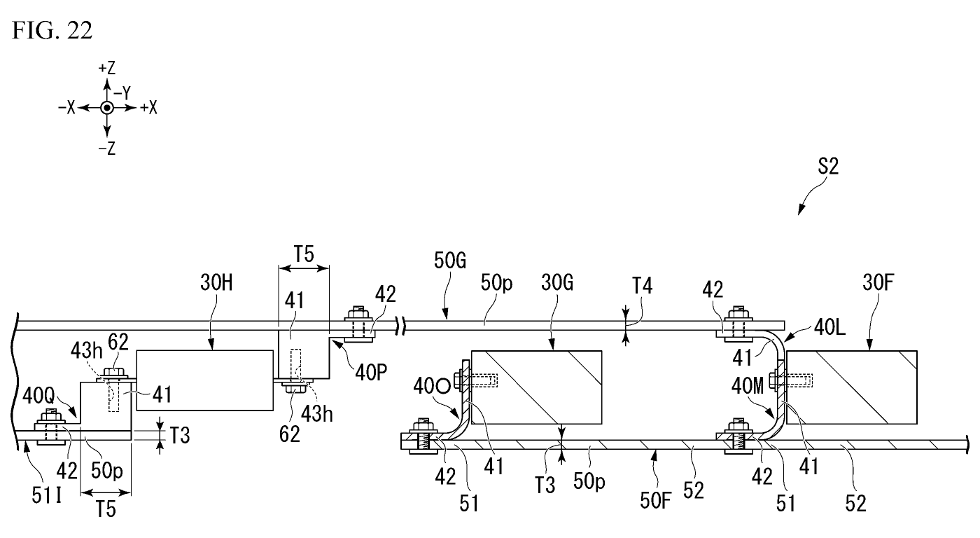

FIG. 22 is a cross-sectional view illustrating the electrical connection unit 1 of the third modification. In the third modification, the connection components 40P and 40Q are formed by the above-described connection component 40X. Then, the connection component 40Q is disposed in the first posture, and is physically and electrically connected to the bus bar 50 (for example, the bus bar 50I) included in the lower routing layer RL1. On the other hand, the connection component 40P is disposed in the second posture, and is physically and electrically connected to the bus bar 50 (for example, the bus bar 50G) included in the upper routing layer RL2.

With such a constitution, the heat storage property of the electrical connection unit can be improved. With this constitution, for example, a temperature rise can be suppressed when a large current flows for a short time. Thus, the thermal characteristics of the electrical connection unit can be improved. According to another viewpoint, with the above constitution, the electronic component is used as the relay member, and the routing member included in the lower routing layer and the routing member included in the upper routing layer can be electrically connected to each other by the two heat storage components disposed in the postures opposite to each other about the electronic component.

As described above, the embodiment and the modification examples have been described. However, the embodiments and the modification examples are not limited to the examples described above. For example, the order of arrangement of the electronic components 30A, 30B, and 30C is not limited to the above examples. For example, the electronic component 30A and the connection components 40A and 40B may be disposed between the electronic component 30B and the electronic component 30C. In addition, the electronic component 30C and the connection components 40E and 40F may be disposed between the electronic component 30A and the electronic component 30B.

Similarly, the order of arrangement of the electronic components 30F, 30G, and 30H is not limited to the above examples. For example, the electronic component 30F and the connection components 40L and 40M may be disposed between the electronic component 30G and the electronic component 30H. In addition, the electronic component 30H and the connection components 40P and 40Q may be disposed between the electronic component 30F and the electronic component 30G.

While preferred embodiments of the invention have been described and illustrated above, it should be understood that these are exemplary examples of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### BRIEF DESCRIPTION OF THE REFERENCE SYMBOLS

1 Electrical connection unit

20A First base member

20B Second base member

20C Third base member (base member)

30 Electronic component

CM Component body

33 Terminal

40 Connection component

50 Bus bar (routing member)

50A Bus bar (first routing member)

50B Bus bar (second routing member)

65 Fastening member

66 Engagement member

What is claimed is:

1. An electrical connection unit comprising:
a first electronic component that includes a component body, a first terminal, and a second terminal;
a first connection component that is connected to the first terminal of the first electronic component;
a first routing member that, when a direction in which the first terminal and the second terminal are adjacent to each other is defined as a first direction, a direction intersecting the first direction and in which the component body and the first connection component are adjacent to each other is defined as a second direction, and a direction intersecting the first direction and the second direction is defined as a third direction, includes a first plate portion along the first direction and the second direction, the first plate portion being disposed on a first side in the third direction with respect to the first electronic component and overlapping at least one of the first electronic component or the first connection component when viewed from the third direction; and
a second routing member that includes a second plate portion along the first direction and the second direction, the second plate portion being disposed on a second side opposite to the first side in the third direction with respect to the first electronic component and overlapping at least one of the first electronic component or the first connection component when viewed from the third direction, wherein between the plate thickness of the second plate portion and the plate thickness of the first plate portion, a smaller plate thickness is equal to or larger than half of a larger plate thickness.

2. The electrical connection unit according to claim 1, wherein
the first plate portion overlaps the first electronic component when viewed from the third direction, and
the second plate portion overlaps the first electronic component when viewed from the third direction.

3. The electrical connection unit according to claim 1, further comprising:
a second electronic component that is adjacent to the first electronic component in the second direction, wherein
the second plate portion extends in the second direction, is disposed on the second side in the third direction with respect to the first electronic component and the second electronic component, and overlaps the first electronic component and the second electronic component when viewed from the third direction.

4. The electrical connection unit according to claim 3 further comprising:
a third electronic component that is located on a side opposite to the first electronic component with respect to the second electronic component and at least partially overlaps the first electronic component and the second electronic component when viewed from the second direction, wherein
the second plate portion extends in the second direction to a vicinity of the third electronic component with respect to the second electronic component when viewed from the first electronic component, and is electrically connected to the third electronic component.

5. The electrical connection unit according to claim 4, wherein
the second electronic component includes a third terminal and a fourth terminal,
the third electronic component includes a fifth terminal and a sixth terminal,
the first plate portion is electrically connected to the first terminal of the first electronic component and the fifth terminal of the third electronic component, and
the second plate portion is electrically connected to the third terminal of the second electronic component and the sixth terminal of the third electronic component.

6. The electrical connection unit according to claim 3, further comprising:
an insulating base member that is disposed between the first electronic component and the second routing member and between the second electronic component and the second routing member, covers the second routing member from the first side, and includes an accommodation portion in which the second routing member is accommodated.

7. The electrical connection unit according to claim 1, further comprising:
a second electronic component that is adjacent to the first electronic component in the second direction, and includes a third terminal and a fourth terminal;
a second connection component that is connected to the third terminal of the second electronic component;
a first fastening member that penetrates the first routing member and the first connection component in the third direction, to which a first engagement member is attached from the second side in the third direction, and that fastens the first routing member and the first connection component; and
a second fastening member that penetrates the second routing member and the second connection component in the third direction, to which a second engagement member is attached from the second side in the third direction, and that fastens the second routing member and the second connection component.

8. An electrical connection unit comprising:
a first electronic component that includes a first terminal and a second terminal adjacent to each other in a first direction;
a second electronic component that is adjacent to the first electronic component in a second direction intersecting the first direction;
a first routing member that, when a direction intersecting the first direction and the second direction is defined as a third direction, includes a first plate portion along the first direction and the second direction, the first plate portion being disposed on a first side in the third direction with respect to the first electronic component and the second electronic component and overlapping the first electronic component when viewed from the third direction; and
a second routing member that includes a second plate portion along the first direction and the second direction, the second plate portion being disposed on a second side opposite to the first side in the third direction with respect to the first electronic component and the second electronic component and overlapping the first electronic component and the second electronic component when viewed from the third direction, wherein between a plate thickness of the second plate portion and a plate thickness of the first plate portion, a smaller plate thickness is equal to or larger than half of a larger plate thickness.
